(19) United States
(12) Patent Application Publication
(10) Pub. No.: US 2017/0206686 A1
(43) Pub. Date: Jul. 20, 2017

(54) Simulated Cardiac Model

(71) Applicant: WILLIAM BEAUMONT HOSPITAL, Royal Oak, MI (US)

(72) Inventor: Nachaat MAZEH, Detroit, MI (US)

(21) Appl. No.: 15/320,958

(22) PCT Filed: Jun. 24, 2015
(86) PCT No.: PCT/US2015/037538

§ 371 Date: Dec. 21, 2016

Related U.S. Application Data
(60) Provisional application No. 62/017,136, filed on Jun. 25, 2014.

(51) Int. Cl. G06T 11/60; G06T 11/00; G06F 3/0484; G09B 23/30

(52) U.S. Cl. CPC G06T 11/60; G09B 23/30; G06T 11/003; G06F 3/04845; G06T 11/001; G06T 2210/41; G06T 2200/24

(57) ABSTRACT

A cardiac modeling system (100) includes an imaging device (120) that captures images of a heart (104) of a patient (102). The imaging device is configured to capture images (133) of hearts (104g) and generate image files (134g) based on the captured images. Each image file associated with a heart. The cardiac modeling system also includes a data processing device (112) in communication with the imaging device and configured to determine a personalized simulated cardiac model (151) of a target heart (104p) based on the image files by: determining a test-bench cardiac model (116) of cardiac fiber orientation based on the image files that indicate fibers of each heart elongate circumferentially and perpendicularly to a radial displacement, and by generating the personalized simulated cardiac model based on the test-bench cardiac model and one or more of the image files of the target heart.

### TECHNICAL FIELD

This disclosure relates to a three-dimensional simulated cardiac model.

### BACKGROUND

Medical imaging refers to several different technologies used to view the human body or a specific organ of the human body for diagnosing, monitoring, or treating medical conditions. Several types of imaging devices are available, such as ultrasound imaging (Echocardiography is the use of ultrasound to image the heart), magnetic resonance imaging (MRI), and x-rays. Ultrasound imaging is used for viewing soft tissues (e.g., muscles and internal organs) by emitting high-frequency sound waves. Ultrasound imaging involves placing a transducer that emits high frequency sound waves against the skin of a patient where a targeted soft tissue is observed. MRI is used to capture images of organs and internal structures of the body. MRI uses strong magnetic fields and radio waves to produce cross-sectional images of the body. Magnetic properties and water content varies between different organs and different areas of the body, which allows distinguishing the organs from one another. MRI provides information about structure in the body that is not visible by a standard x-ray, an ultrasound, or a computed tomography (CT) exam.

### SUMMARY

One aspect of the disclosure provides a cardiac modeling system that includes an imaging device that captures images of multiple hearts. The imaging device generates image files based on the captured images. Each image file is associated with a corresponding heart. The cardiac modeling system includes a data processing device in communication with the imaging device. The data processing device determines a personalized simulated cardiac model of a heart of a target patient based on the image files of hearts of patients by: determining a test-bench cardiac model of cardiac fiber orientation based on the image files; and generating the personalized simulated cardiac model based on the test-bench cardiac model and image files of the heart of the target patient. The test-bench cardiac model modeling fibers of each heart as elongated circumferentially and perpendicularly to a radial displacement.

Implementations of the disclosure may include one or more of the following optional features. In some implementations, the data processing device is configured to send the personalized simulated cardiac model to a display in communication with the data processing device for rendering in a graphical user interface. The rendered personalized simulated cardiac model may have at least one user selectable portion that upon selection, allows customization of the personalized simulated cardiac model. The imaging device may include one or more of a Magnetic Resonance Imaging (MRI) device, an echocardiogram, and a sheer wave imaging device. The processing device may be configured to receive speckle data from the imaging device. The speckle data may include at least one of speckle strain and speckle velocity. In some examples, the data processing device determines the cardiac fiber orientation. The data processing device may generate a mechanical cardiac model based on the test-bench model by: generating a plurality of voxels with cardiac fibers oriented in a predetermined direction; modifying the orientation of the cardiac fibers in each voxel to represent the cardiac fiber orientation determined based on the speckle data; and combining the plurality of voxels to generate the mechanical cardiac model. Combining the plurality of voxels may include applying finite element analysis on the plurality of voxels.

In some implementations, the data processing device generates the personalized simulated cardiac model by: implementing a Bidomain model in the mechanical cardiac model to represent cardiac tissue as a continuum; and implementing current kinetics in the Bidomain model to emulate ionic channels and flow of ions in the cardiac tissue. Implementing the Bidomain model may include solving Bidomain equations through discretization and constant iteration. The data processing device may receive cardiac contraction data from image files of the heart of the target patient; and impose cardiac contraction constraints on the mechanical cardiac model to personalize the mechanical cardiac model to match the cardiac contractions of the patient. The cardiac contraction data may include at least one of a length of contraction and a length of expansion. The data processing device may receive the cardiac contraction data from one or more of a Magnetic Resonance Imaging device, an echocardiogram, and a sheer wave imaging device.

The cardiac modeling system may also include a graphical user interface, a network interface for communicating with the data processing device over a network, and a data processing hardware in communication with the graphical user interface and the network interface. The data processing hardware is configured to: receive the personalized simulated cardiac model from the data processing device and display personalized simulated cardiac model on the display. The cardiac modeling system may further include an input device in communication with the data processing hardware and the graphical user interface. The data processing hardware receives, via the input device, an input regarding a simulated condition, and wherein the data processing hardware modifies the personalized simulated cardiac model based on the input regarding the simulated condition, and sends the modified personalized simulated cardiac model to the computer. The graphical user interface may display the modified three-dimensional cardiac model on the graphical user interface. In some examples, the input regarding the simulated condition includes a command to remove a mass. The data processing hardware may modify the personalized simulated cardiac model by removing a representation of the mass from the personalized simulated cardiac model. In some examples, the input regarding the simulated condition includes administering a medication that alters ion concentration in a cardiac muscle; and the data processing hardware modifies the personalized simulated cardiac model by modifying the current kinetics to alter at least one ionic channel and the flow of ions in the ionic channel.

Another aspect of the disclosure provides a method of determining a personalized simulated cardiac model of the heart of the target patient. The method includes receiving, at the data processing hardware, images of multiple hearts of patients from an imaging device. The method includes generating, by the data processing hardware, image files based on the captured images. In some examples, each image file is associated with a corresponding heart of a patient. In addition, the method includes receiving, at the data processing hardware, a target image file of a heart of a target patient. The method includes determining, at the data processing hardware, a personalized simulated cardiac model of the heart of the target patient based on the image files. The method includes determining a test-bench cardiac model that includes cardiac fiber orientation based on the image files. The test-bench model cardiac model modeling fibers of each hear as elongating circumferentially and perpendicularly to a radial displacement. The method includes generating the personalized simulated cardiac model based on the test-bench cardiac model and image files of the heart of the target patient.

In some examples, the method includes sending, from the data processing hardware, the personalized simulated cardiac model to a display in communication with the data processing hardware for rending in a graphical user interface. The rendered personalized simulated cardiac model may have at least one user selectable portion that upon selection, allows customization of the personalized simulated cardiac model. The method may also include receiving, at the data processing hardware, speckle data from the imaging device. The imaging device may include one or more of a Magnetic Resonance Imaging device, an echocardiogram, and a sheer wave imaging device. The speckle data may include at least one of speckle strain and speckle velocity. The method may also include determining, at the data processing hardware, the cardiac fiber orientation.

In some implementations, the method further includes generating, at the data processing hardware, a mechanical cardiac model based on the test-bench model by: generating a plurality of voxels with cardiac fibers oriented in a predetermined direction; modifying the orientation of the cardiac fibers in each voxel to represent the cardiac fiber orientation determined based on the speckle data; and combining the plurality of voxels to generate the mechanical cardiac model. Combining the plurality of voxels may include applying finite element analysis on the plurality of voxels. In some examples, the method includes generating, at the data processing hardware, the personalized simulated cardiac model by: implementing a Bidomain model in the mechanical cardiac model to represent cardiac tissue as a continuum; and implementing current kinetics in the Bidomain model to emulate ionic channels and flow of ions in the cardiac tissue. Implementing the Bidomain model, may include solving Bidomain equations through discretization and constant iteration.

The method may also include receiving, at the data processing hardware, cardiac contraction data of the target patient, and imposing, at the data processing hardware, cardiac contraction constraints on the mechanical cardiac model to personalize the mechanical cardiac model to match the cardiac contractions of the target heart. The cardiac contraction data may include at least one of a length of contraction and a length of expansion. The method may also include receiving, at the processing device, the cardiac contraction data from one or more of a Magnetic Resonance Imaging device, an echocardiogram, and a sheer wave imaging device.

In some implementation, the method includes imposing, at the data processing hardware, cardiac contraction constraints. Additionally, the method may include displaying, on a display in communication with the co data processing hardware, personalized simulated cardiac model. The method may also include; receiving, via an input device in communication with the data processing hardware, an input regarding a simulated condition; modifying, at the data processing hardware, the personalized simulated cardiac model based on the input regarding the simulated condition; and sending, at the data processing hardware, the modified personalized simulated cardiac model to the computer. The method may further include displaying, on the display, the modified personalized simulated cardiac model.

Another aspect of the disclosure provides a cardiac modeling system that includes an imaging device and processing circuitry. The imaging device is configured to capture cardiac imagery indicative of fiber orientation of various areas in a heart of a subject. The processing circuitry (112, 138) is configured to obtain the cardiac imagery captured by the imaging device, obtain a cardiac model indicative of a geometry of a heart, and generate a cardiac fiber orientation map by reconstructing the cardiac imagery according to the cardiac model. The processing circuitry is also configured to produce a cardiac activation simulation of the heart of the subject based on the cardiac fiber orientation map. The cardiac activation simulation is indicative of a propagation behavior of electric signals within the heart of the subject.

The details of one or more implementations of the disclosure are set forth in the accompanying drawings and the description below. Other aspects, features, and advantages will be apparent from the description and drawings, and from the claims.

### BRIEF DESCRIPTION OF DRAWINGS

FIG. 1 is a schematic view of an exemplary cardiac modeling system.

FIG. 2A is a schematic view of determining an exemplary template model from ex vivo studies of healthy population of hearts, which is used to guide the patient specific cardiac model.

FIG. 2B is a schematic view of the resultant model of FIG. 2A.

FIG. 2C is a schematic view of an ideal fiber orientation in a slab of cardiac tissue.

FIG. 2D is a schematic view of an ideal fiber and orientation of two elements of volume.

FIGS. 2E and 2F are schematic views of a scare representation within the ideal fiber representation in an element of volume of cardiac tissue.

FIG. 3 is a schematic view of an exemplary Bidomain circuit representation used to model cardiac tissue.

FIG. 4 is a schematic view of an exemplary arrangement of operations for generating a patient specific cardiac model.

FIG. 5A is a schematic view of exemplary Cine-Dense imaging of a healthy patient.

FIGS. 5B-5E are schematic views of exemplary velocity measurements using STE to estimate fiber orientation that populate the voxel of fibers used to generate a patient specific cardiac model.

FIGS. 6A and 6B are schematic views of an exemplary representation of the elements from different imaging scans.

FIG. 7 is a schematic view of an exemplary method of determining the fiber orientation from velocity and strain measurements during imaging scans used to generate a patient specific cardiac model.

FIGS. 8A and 8B are schematic views of an exemplary data processor for implementing a method to couple both cardiac electrical activation and contraction for implementing the cardiac model simulation.

FIG. 9 is a schematic view of an exemplary method to compute coordinates of points on an isochrone surface.

FIG. 10 is a schematic view of an exemplary method to generate a personalized simulated three-dimensional cardiac model.

FIG. 11 is a schematic view of an exemplary cardiac modeling system.

Like reference symbols in the various drawings indicate like elements.

### DESCRIPTION

In some implementations, a system of the present disclosure uses speckle tracking information to produce a simulated personalized three-dimensional cardiac model that describes cardiac anatomy including the fiber orientation of the heart. The system generates the patient-specific anatomy using algorithms based on a “rubber band” approach. The “rubber band” approach states that a fiber elongates circumferentially and perpendicular to its radial displacements, thus the system considers the fiber to be locally circumferential. Speckle motion analysis provides local information that the system uses to produce the fiber orientation that allows the generation of the simulated personalized three-dimensional cardiac model that depends on muscle fiber. The system uses known and available Atlases of the cardiac anatomy to guide the reconstruction of the cardiac geometry, i.e., the ensemble of fibers orientation, and a leading pathway of cardiac activation, i.e., electric wave fronts that propagate in the cardiac muscle to produce the cardiac muscle contraction.

The system generates an electric model of the activation based on a Bidomain model of tissue and model of cell kinetics. The system reproduces the cardiac cell activation using parallel computing based on Message Passing Interface (MPI) and Finite Element Method (FEM) to reproduce the patient-specific cardiac mapping. The system adds muscle contractions as a constraint from image files to an imposition on a computer display, i.e., the patient-specific simulation conforms to the patient-specific contraction. Therefore, the system reproduces whole muscles anatomy of a heart by providing intra mural information and electric activation, which is not detectable. The system is configured to simulate the activation of a heart based on a patient specific-anatomy reconstructed from speckle information, and resulting in a non-invasive cardiac mapping of the patient. In addition the system seeks to provide information of the whole cardiac muscle anatomy including its full electric activation. The system produces a patient-specific simulation to detect regions of conduction blocks, conduction slow or scares within the muscle to allow accurate assessment and treatment of arrhythmic conditions.

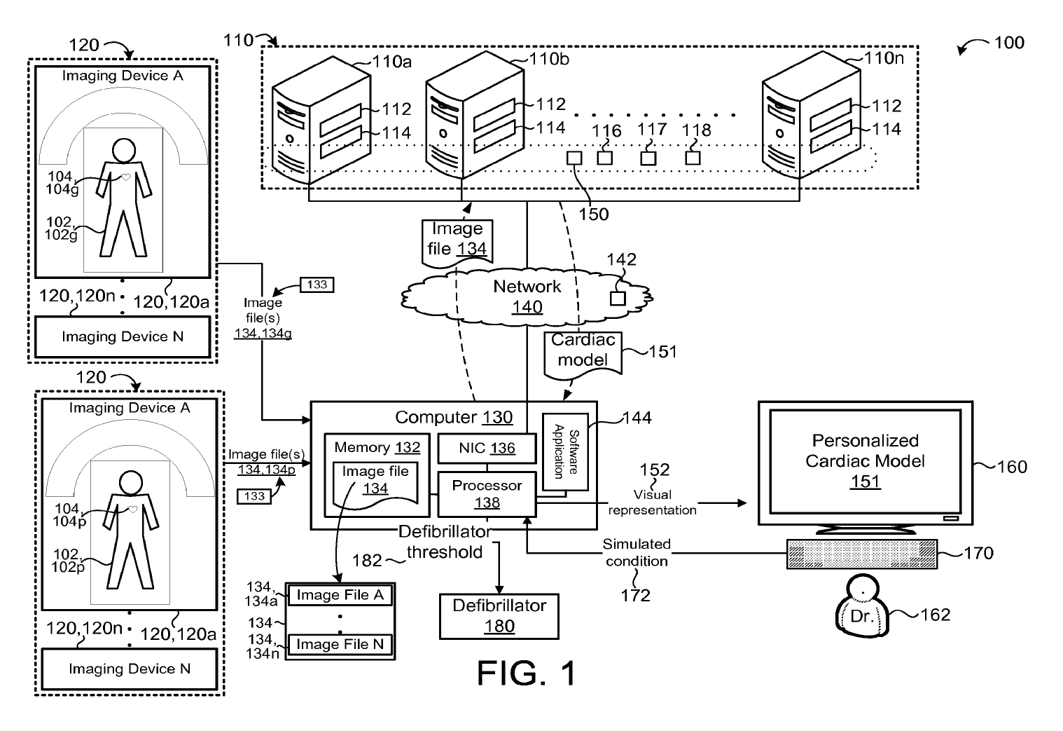

Referring to FIG. 1, a three-dimensional cardiac modeling system 100 models the heart 104 of a target patient 102, 102p and generates a simulated personalized three-dimensional cardiac model 151 of the heart 104, 104p of the target patient 102p. The simulated personalized three-dimensional cardiac model 151 is based on at least one data source (e.g., imaging device(s) 120); each imaging device 120 may provide a different type of information relating to the heart 104 or a different expression of the same type of information. The modeling system 100 generates a three-dimensional mechanical model 150 and then includes electrical currents to the model 150 resulting in a simulated personalized three-dimensional cardiac model 151. For example, the imaging device 120 may include one or multiple imaging devices providing different information. Therefore, the cardiac modeling system 100 analyses the data (e.g., data file(s) or imaging file(s) 134) received from the data source(s) to generate the simulated personalized three-dimensional cardiac model 151 of the heart 104.

The heart 104 is a highly integrated organ with structures ranging from genes to cells to the whole organ. The heart 104 is a hollow muscular organ that pumps blood throughout the blood vessels of a human to the various parts of the patient body 102 by repeated rhythmic contractions. The heart 104 includes cardiac muscle tissue responsible for the heart's ability to pump the blood into the blood vessels. The human heart 104 is enclosed in a pericardium, which is a double-walled sac. The outer wall of the human heart 104 includes three layers: an outer layer, a middle layer, and an inner layer. The outer layer is called the epicardium or visceral pericardium. The middle layer is called the myocardium and includes cardiac muscles. The inner layer is known as the endocardium and is in communication with the blood and the heart pumps. Moreover, the heart 104 includes four chambers: first and second superior atria and first and second inferior ventricles. During each heart beat cycle, each atria contrasts first causing the blood in each atria to flow to its respective ventricle. Then the ventricles contrast causing the blood to flow out of the heart 104.

A portion of the human heart 104, known as the sinoatrial (SA) node or the pacemaker, sets the rate and timing of the contraction of the cardiac muscle cells. The SA node generates electrical impulses that spread through the walls of each atrium, which causes both atria to contract simultaneously. The heart 104 includes an atrioventricular node (AV) or a relay node. The impulses from the SA node also spread to the atrioventricular node, which causes a 0.1 second delay of the impulse before allowing them to spread to the walls of the ventricle. The delay is key to the function of the heart 104, because it causes each atrium to completely empty the blood it contains before the ventricles contract. The heart 104 also includes Purkinje fibers located in the inner ventricular walls of the heart 104 right under the endocardium. The Purkinje fibers allow the heart conduction system to create synchronized contractions of its ventricles; therefore, the Purkinje fibers are important for maintaining a consistent heart rhythm. In some cases, if the SA node fails, the AV node becomes the heart's pacemaker. Moreover, if the AV node fails, the Purkinje fibers act as the pacemaker. The Purkinje fibers generate action potentials at a lower frequency than the AV or SA nodes; that is why the Purkinje do not normally control the heart 104. A single heart beat lasts about 0.8 seconds and generates impulses that produce electrical currents. The produced electrical currents are then conducted through body fluids to the skin, where they can be detected by electrodes as an electrocardiogram (ECG or EKG).

Arrhythmia (also known as cardiac dysrhythmia or irregular heartbeat), where the electrical activity of the heart 104 is irregular (i.e., faster or slower than normal), occurs at the cellular and molecular level of the heart 104 and leads to a disturbance of the sinus rhythm of the heart 104, which may ultimately be fatal to the patient 102. Arrhythmia may occur in the atria or in the ventricles of a person at any age. In many instances, arithmetic conditions relate to the chaotic cardiac propagation of the heart 104, where the electrical waves propagating through the heart 104 have an abnormal pattern due to blockage in their normal pathway. Thus, it is desirable to have a three-dimensional cardiac modeling system 100 capable of generating a simulated personalized three-dimensional cardiac model 151 (also referred to as a whole-heart model) of the human heart 104 that shows the electrical and mechanical movement of the heart 104 in real time (which includes a simulation of the outer, middle, and inner layers of the heart 104). Such a whole-heart model 151 determines what causes the abnormal propagation pattern of the electrical waves of the target patient heart 104p. For example, the three-dimensional cardiac modeling system 100 helps determine the electrical wave pathways within the heart 104. In addition, the three-dimensional cardiac modeling system 100 may find alternative electrical pathways when there is a mass or a fiber abnormality blocking the pathway, which causes a split in the electrical wave (into two or more waves). Some previous techniques used to monitor the myocardium (middle layer of the outer wall of the heart 104 that includes the cardiac muscles) of the heart 104 are invasive. Therefore, it is desirable to have a non-invasive technique to provide a simulation of the electrical activity of the patient's heart 104.

Masses in the myocardium (middle layer) may block normal wave propagation or may induce reentry of the electrical wave, which creates fibrillation (e.g., atrial fibrillation or ventricular fibrillation). The cardiac modeling system 100 models the heart 104 of a patient or patient body 102; therefore, the modeling system shows/replicates the patient-specific fibrillation based on the patient's heart 104 allowing a physician 162 to monitor how the fibers of the middle layer conduct the electrical waves. Moreover, organ structure of the patient body 102 plays an important role in the patterns of wave propagation and repolarization: the cardiac modeling system 100 allows a physician 162 to observe and investigate how the heart size, myocardial properties, and spatial distribution of cell type affects functional action potential duration (ADP) dispersion within the ventricle volume of a patient's heart 104.

Moreover, the cardiac modeling system 100 reconstructs the motion of the patient's heart 104 from in vivo imaging, through safe and minimally invasive techniques that reproduces deformation at the structural level rather than at the subcellular level. The cardiac modeling system 100 reconstructs the heart contractions from patient-specific strain measurements for the simulated personalized three-dimensional model 151. Thus, the structural behavior of the heart 104 determines how the electro-mechanical coupling at the cellular level and organ level behaves.

The cardiac modeling system 100 generates a whole-heart model 151 that is specific to a target patient 102p by using a test bench model 116 in addition to image files 134 associated with the target patient heart 104p. Moreover, the cardiac modeling system 100 includes modular components, for example, the imaging device 120 may include one or more of a Magnetic Resonance Imaging (MRI) device, an echocardiogram, a sheer wave imaging (SWI) device, or any other device capable of capturing images of an organ (e.g., the heart 104). The cardiac modeling system 100 is configured to address mechanisms of cardiac dysfunctions, to simulate applications of therapies for cardiac disease and to and to give insights into both the electrophysiological and electromechanical functions from genes, to cells and to whole structure. Moreover, the cardiac modeling system 100 includes a computer 130 that interacts with a user 162 (e.g., a doctor) allowing the user 162 to manipulate the whole-heart model 151, where the whole-hearted simulated model 151 is computed in real-time, which leads to positively contributing to a patient's diagnostics, prognostics, and system health management.

Referring back to FIG. 1, the cardiac modeling system 100 includes a computer 130 having non-transitory memory 132 (e.g., memory hardware), a network interface 136, and a computer data processor 138 (e.g., hardware processor). The network interface 136 i.e., a network interface card (NIC) (also known as a network interface controller, network adapter, or LAN adapter) may be a computer hardware component that connects the computer 130 to the network 140. In some examples, the computer 130 includes or is in communication with a display 160 (e.g., touch screen or non-touch screen) and an input device 170, such as a keyboard. The combination of the display 160 and the input device 170, allow a user 162, such as a physician, to interact with the cardiac modeling system 100.

The computer 130 is in communication with a data processor 110 via a network 140. In some embodiments the data processor 110 is a remote data processor. In some examples, the computer 130 and the data processor 110 are the same. The data processor 110 includes a data processing device 112 and non-transitory memory 114 (e.g., memory hardware), where the data processing device 112 is in communication with the non-transitory memory 114. In some examples, the data processor 110 performs parallel computing, which is a form of computation where many calculations are carried out simultaneously, resulting in a decreased total time of computation. Parallel computing divides a larger problem into multiple smaller problems, and each smaller problem is solved concurrently/in parallel.

The non-transitory memory 114, 132 (of the computer 130 or the data processor 110) may be one or more physical device(s) used to store programs (e.g., sequences of instructions) or data (e.g., program state information) on a temporary or permanent basis for use by a computing device 110, 130 (e.g., the computer 130 or the data processor 110). The non-transitory memory 114, 132 may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

As shown in FIG. 1, the data processor 110 includes multiple data processing devices 100a-n each having a data processing device 112 and non-transitory memory 114. The non-transitory memory 114 may store instructions that the computing resources 112 may execute to implement the cardiac modeling system 100.

The network 140 may include any type of network that allows sending and receiving communication signals, such as a wireless telecommunication network, a cellular telephone network, a time division multiple access (TDMA) network, a code division multiple access (CDMA) network, a Global system for mobile communications (GSM), a third generation (3G) network, a fourth generation (4G) network, a satellite communications network, and other communication networks. The network 140 may include one or more of a Wide Area Network (WAN), a Local Area Network (LAN), and a Personal Area Network (PAN). In some examples, the network 140 includes a combination of data networks, a combination of telecommunication networks, or a combination of data and telecommunication networks. The computer 130 and the data processor 110 communicate with each other by sending and receiving signals (wired or wireless) via the network 140. Moreover, the computer 130 may communicate with an imaging device(s) 120 by sending and receiving signals (wired or wireless) via the network 140. In some examples, the imaging device(s) 120 and the data processor 110 communicate with each other by sending and receiving signals (wired or wireless) via the network 140. The network 140 may provide access to cloud computing resources, which may be elastic/on-demand computing and/or storage resources 142 available over the network 140. The term ‘cloud’ services generally refers to a service performed not locally on a user's device, but rather delivered from one or more devices accessible via one or more networks 140.

In some implementations, the cardiac modeling system 100 executes a software application 144 that allows a user 162 (e.g., a doctor, a nurse, or a registered professional) to control the imaging device 120, by selecting an imaging device 120 to take images, the settings of the imaging device 120 based on a patient 102, the number of images that the imaging device 120 should take of the patient 102, and the body organ or the body portion that the imaging device 120 should capture images of. In addition, the software application 144, as will be discussed in more details below, allows the user 162 to manipulate or alter a property of the simulated personalized three-dimensional cardiac model 151 and simulate different results based on the manipulation to see how the simulated personalized three-dimensional cardiac model 151 behaves under different circumstances (e.g., removing a node of the simulated personalized three-dimensional cardiac model 151 and simulating the model 151 to observe how the three-dimensional model behaves). A software application 144 (i.e., a software resource 110) may refer to computer software that causes a computing device to perform a task. In some examples, a software application is referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The cardiac modeling system 100 includes an imaging device 120 that captures a visual representation of the interior of the patient body 102. The imaging device 120 may include a magnetic resonance imaging device (“MRI”), an electrocardiogram (“ECG”), an echocardiogram (“ECHO”), or shear wave imaging (“SWI”). The imaging device 120 produces an imaging file 134 after capturing images of the patient body 102 or parts thereof, e.g., heart 104. The imaging file 134 may have a DICOM (Digital Imaging and Communications in Medicine) file format. DICOM is a standard for handling, storing, printing, and transmitting information in medical imaging specific to DICOM file format. Therefore, the imaging device 120 captures an image i.e., imaging file 134, and stores the image in the non-transitory memory 132 of the computer 130. In some examples, the imaging file 134 is stored in the non-transitory memory 114 of the data processor 110. The imaging file 134 may include imaging data, such as speckle data (including strain and velocity measurements of the speckle, which may be determined by the imaging device 120). Speckle is the smallest visual representation of the imaged area (e.g., heart 104), and may be used to determine a strain and a strain velocity (or rate).

Speckle tracking is a technique used to analyze the motion of tissues of an organ (e.g., the heart 104) by utilizing ultrasonic sound waves to generate interference patterns and natural acoustic reflections. The information provides both quantitative and qualitative information relating to the movement and deformation of the tissues of the organ. Strain is the fractional or percentage change in the dimensions of an object (e.g., an organ, such as a heart 104) compared to the object's original dimensions. For example, the strain of the heart 104 may be measured while it expands and contracts. In addition, strain rate (strain velocity) is the speed at which the deformation occurs, for example, the rate at which the heart 104 contracts/expands. Strain includes normal strain and shear strain, each defined by three directional components (x, y, z). In some examples, the left ventricle deformation of the heart 104 is defined by three normal strains (longitudinal, circumferential, and radial) and three shear strains (circumferential-longitudinal, circumferential-radial, and longitudinal-radial). The strain and the strain rate are essential elements in determining a three-dimensional mechanical model 151, since the data processor 110 utilizes these measurements to determine a fiber orientation within the heart 104 (discussed below).

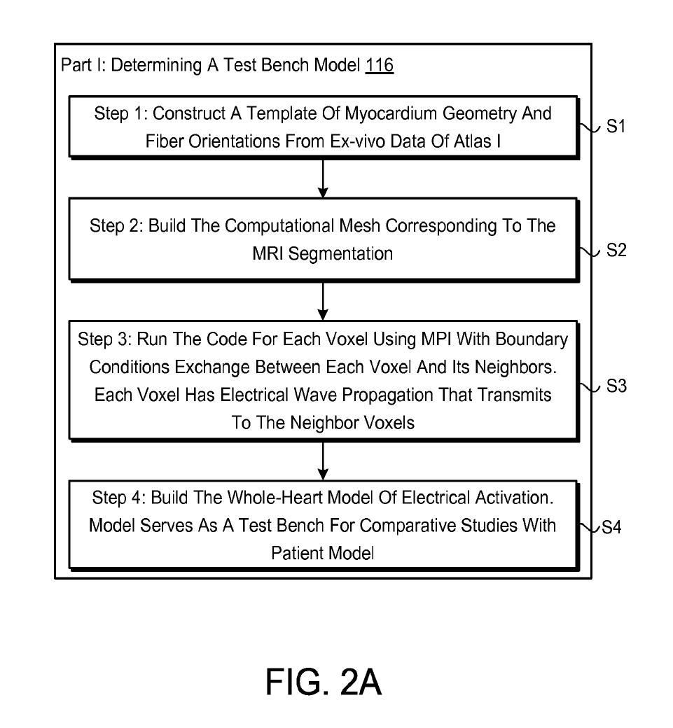

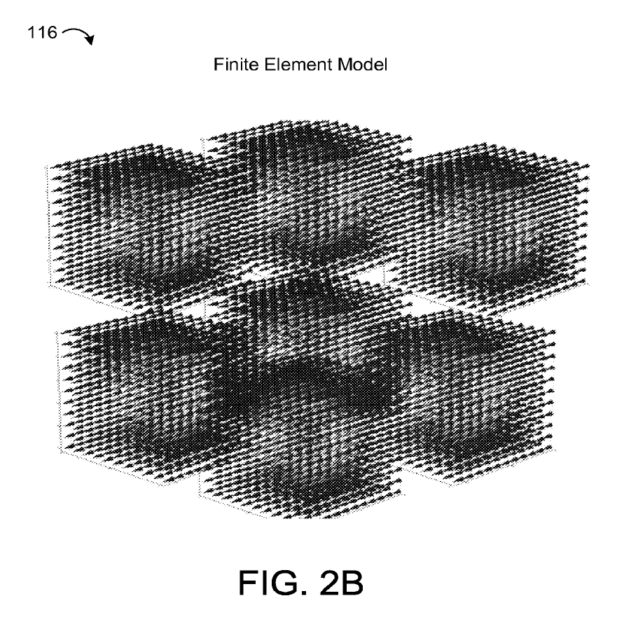

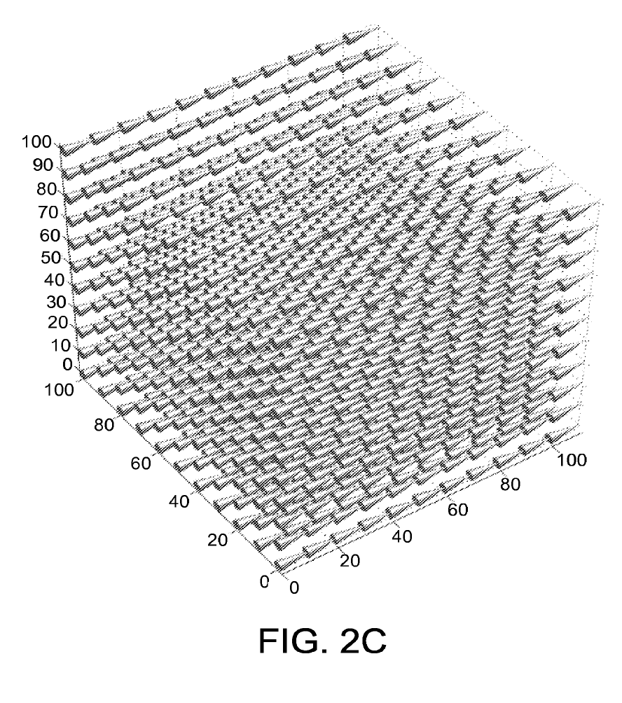

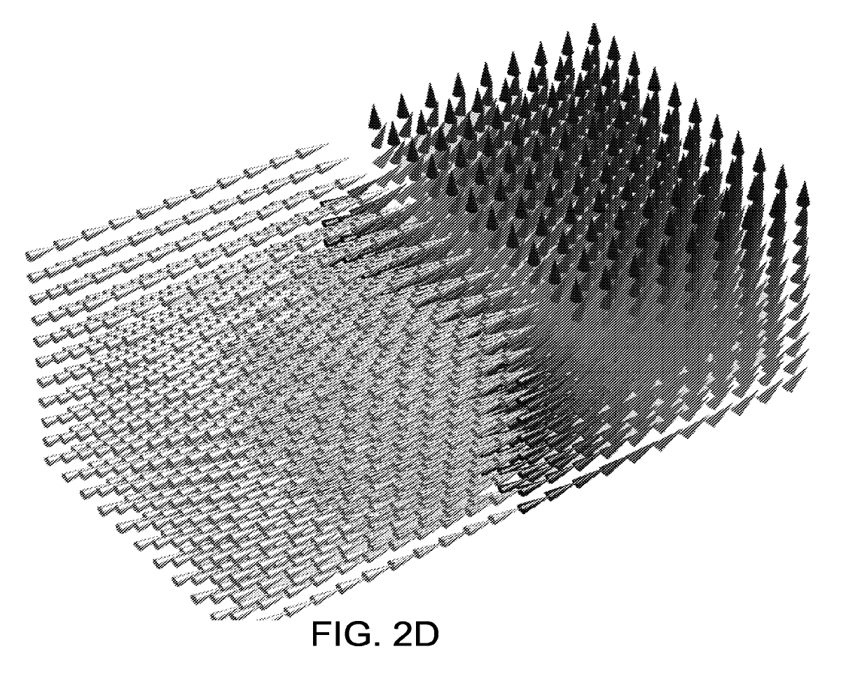

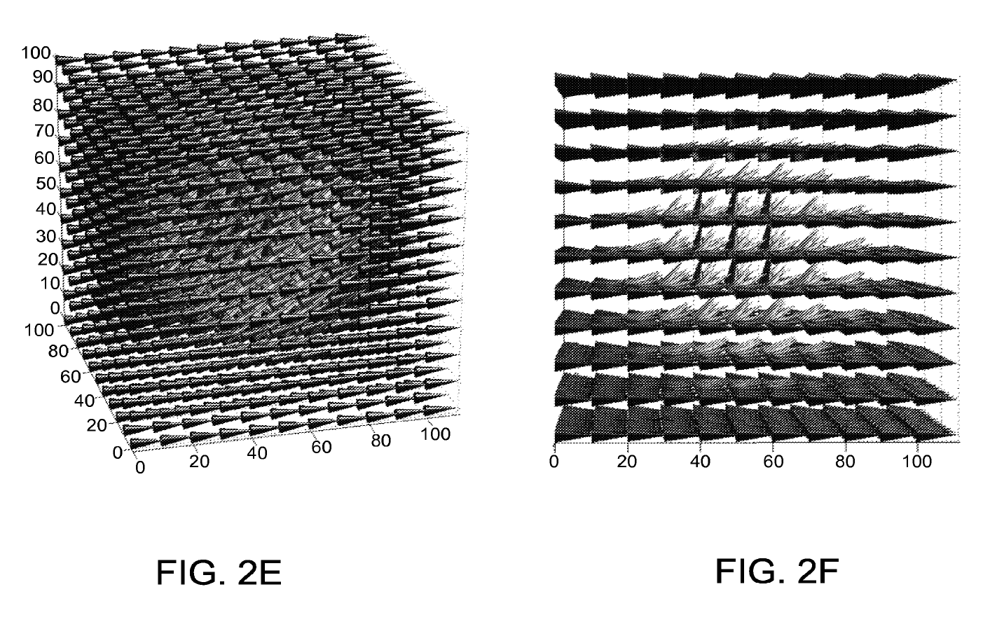

Referring also to FIGS. 2A-2B, the data processor 110 is capable of determining/generating the personalized three-dimensional model 151 after completing two steps. First (Part I), the data processor 110 determines a test bench model 116 of the heart 104 that serves as a test bench for the patient-specific three-dimensional simulated model 151; and second (Part II), the data processor 110 determines the patient-specific three-dimensional simulated model 151 based on one or more imaging devices 120, the test bench model 116 of the heart 104, and the three-dimensional mechanical model 150.

The first part (Part I) includes multiple steps. The data processor 110, at Step S1, constructs a template of myocardium (middle layer of the heart 104) geometry and the fiber orientation from imaging files 134 of multiple patients 102g (group of patients 102 (e.g., Atlas I, also available on the world wide web at http://cvrgrid.org/datasets) to create an ideal fiber representation file 117 that includes information of the preferred direction of the electrical wave within the fibers. At Step S2, the data processor 110 builds a computational mesh that corresponds to the MRI segmentation (e.g., voxel size 3×3×5 mm3, matrix size per slice is 128×75 pixels). Then, at Step S3, the data processor 110 uses message passing interface (MPI) to execute boundary condition exchange between each voxel and its neighbors. Each voxel has electrical wave propagation that transmits to the neighbor voxels (See FIGS. 2D and 2E). MPI is a standardized and portable message-passing system used in conjunction with parallel computing. Once all the computations are completed, the data processor 110 at Step S4, builds test bench model 116 of electrical activation as shown in FIG. 2B. The test bench model 116 serves as a test bench for comparative studies with the three-dimensional mechanical model 150. At this stage, the electrical activation of the whole-heart is complete and shown in the test bench model 116. Next the data processor 110 implements the mechanical contraction obtained from the ideal fiber representation file 117 for the code run using patient-specific fiber geometry and orientation (e.g., obtained from the image file(s) 134).

In some implementations, the data processor 110 includes one or more reference files 118 (e.g., Atlas file) stored in the non-transitory memory 114. Each file may provide different information, (e.g., ATLAS I, ATLAS II). The reference file 118 includes known structure and behavior of the human heart 104, and is based on the study and an analysis of multiple human hearts 104. The reference file 118 provides the preferred structure of the human heart 104, for example, the reference file 118 may determine that a variable X of a calculation may only be within a known threshold, therefore, the data processor 110, only executes the calculations based on the known threshold of variable X. In other words, the reference file 118 provides a working range for variables needed for computations to create the three-dimensional mechanical model 150, resulting in a refined computation process for each three-dimensional mechanical model 150. This restricts the amount of computation of the data processor 110, resulting in higher efficiency and less computation time.

In some implementations, the data processor 110 includes the test bench model 116 that includes information of the preferred direction of the electrical wave within the fibers. If the target patient 102p has an abnormality or scar in his heart 104, the data processor 110 uses the ideal fiber representation file 117 to modify the test bench model 116 based on the patient's heart abnormality, making the test bench model 116 a personalized fiber representation file 117, which allows a physician 162 to simulate certain conditions, and observe how certain conditions affect the personalized fiber representation file.

As shown in FIG. 2C, the ideal fiber orientation in a slab of cardiac tissues (volume element) has 100×100×100 nodes (cones are used to show the fiber direction) with a space step of 0.1 mm corresponding to single fiber length. The Bidomain represents a continuum of these fibers within a volume element.

FIG. 2D shows two elements of volume connected on one surface using a one-dimensional topology message passing interface (MPI) to distribute work load to two processors 110. The two elements share one boundary, through which they exchange activation data. During processing every processor handles a single volume element while exchanging data with its neighbors via MPI.

FIGS. 2E and 2F show a scare representation within an ideal fiber orientation in an element of volume of cardiac tissue. The two elements exchange boundary conditions during processing using MPI, a 1-Dimensional topology in this representation.

As previously mentioned, the data processor 110 creates a test bench model 116 that serves as a test bench for comparative studies with a patient model 150. For the test bench representation, the data processor 110 uses prolate spheroidal coordinates (η, ξ, φ) with origin at the base of a global Cartesian system (x,y,z) while local reference frame is Cartesian with unit vectors described by eᵤ, eᵥ, and e_{w} (bold character for vector notation).

x=a(1−η²)^{1/2}(ξ²−1)^{1/2} cos φ (1)

y=a(1−η²)^{1/2}(ξ²−1)^{1/2} cos φ (2)

z=aηξ (3)

or

$$\begin{matrix}ξ = \frac{1}{2 a} ( \sqrt{{x}^{2} + {y}^{2} + {( z + a )}^{2}} + \sqrt{{x}^{2} + {y}^{2} + {( z - a )}^{2}} ) & ( 4 ) \\ ξ = \frac{1}{2 a} ( \sqrt{{x}^{2} + {y}^{2} + {( z + a )}^{2}} - \sqrt{{x}^{2} + {y}^{2} + {( z - a )}^{2}} ) & ( 5 ) \\ φ = arctan ( \frac{y}{x} ) & ( 6 )\end{matrix}$$

The position of the origin of the local system includes the following relationship with tangential unit vectors η_{φ0} and η_{θ0}, and normal unit vector η_{λ}.

\vec{eᵤ}·\vec{η_{θ0}}=\vec{eᵤ}·\vec{η_{φ0}}=0 (7)

and

\vec{eᵥ}·\vec{η_{θ0}}=1 (8)

with (eᵤ, eᵥ, e_{w}) being an orthonormal set. A fiber with one space step length has position (u,v,w) and orientation (θ, φ) in the local system.

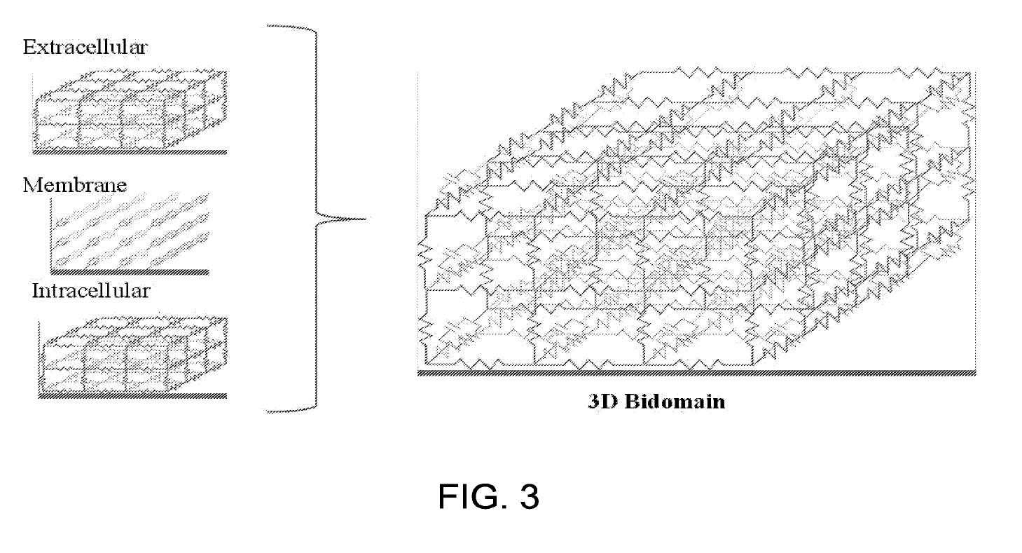

A Bidomain model is a three-dimensional extracellular and intracellular Bidomain cell model (Tung L. A bi-domain model for describing ischemic myocardial D-C potentials, Ph.D. dissertation. Massachusetts Inst Technol, Cambridge, Mass., 1978), which is equivalent to a network of resistors coupled by a membrane described by resistors and capacitors as shown in FIG. 3. The Bidomain model may be represented by the following coupled partial differential equations:

∇·(\tilde{g}ₑ+\tilde{g}ᵢ)∇Vₑ=−∇·\tilde{g}ᵢ∇Vₘ (9)

$$∇ \cdot {\tilde{ℊ}}_{e} ∇ {V}_{e} = - β [ {C}_{m} \frac{\partial {V}_{m}}{\partial t} + {I}_{ion} ( {V}_{m} , t ) ] \qquad ( 10 )$$

where Vₑ is the extracellular potential (V), \tilde{g}ᵢ and \tilde{g}ₑ are the intracellular and extracellular conductivity tensors (S/m), β is the ratio of membrane surface area to tissue volume (the surface-to-volume ratio, 1/m), and Cₘ is the membrane capacitance per unit area (F/m²).

The data processor 110 may solve ∇·\tilde{g}ᵢ∇Vₘ using:

$$\begin{matrix}{\tilde{g}}_{i} ∇ {V}_{m} = ( \begin{matrix}gixx & gixy & gixz \\ giyx & giyy & giyz \\ gizx & gizy & gizz\end{matrix} ) ( \begin{matrix}\frac{\partial {V}_{m}}{\partial x} \\ \frac{\partial {V}_{m}}{\partial y} \\ \frac{\partial {V}_{m}}{\partial z}\end{matrix} ) & ( 11 ) \\ \{ \begin{matrix}gixx \frac{\partial {V}_{m}}{\partial x} & + gixy \frac{\partial {V}_{m}}{\partial y} & + gixz \frac{\partial {V}_{m}}{\partial z} \\ giyx \frac{\partial {V}_{m}}{\partial x} & + giyy \frac{\partial {V}_{m}}{\partial y} & + giyz \frac{\partial {V}_{m}}{\partial z} \\ gizx \frac{\partial {V}_{m}}{\partial x} & + gizy \frac{\partial {V}_{m}}{\partial y} & + gizz \frac{\partial {V}_{m}}{\partial z}\end{matrix} \} ⇔ (* ) & ( 12 ) \\ ∇ (* ) = \frac{\partial }{\partial x} gixx \frac{\partial {V}_{m}}{\partial x} + gixx \frac{{\partial }^{2} {V}_{m}}{\partial {x}^{2}} + \frac{\partial }{\partial x} gixy \frac{\partial {V}_{m}}{\partial y} + gixy \frac{{\partial }^{2} {V}_{m}}{\partial x \partial y} + \frac{\partial }{\partial x} gixz \frac{\partial {V}_{m}}{\partial z} + gixz \frac{{\partial }^{2} {V}_{m}}{\partial x \partial z} + \frac{\partial }{\partial y} giyx \frac{\partial {V}_{m}}{\partial x} + giyx \frac{{\partial }^{2} {V}_{m}}{\partial y \partial x} + \frac{\partial }{\partial y} giyy \frac{\partial {V}_{m}}{\partial y} + giyy \frac{{\partial }^{2} {V}_{m}}{\partial {y}^{2}} + \frac{\partial }{\partial y} giyz \frac{\partial {V}_{m}}{\partial z} + giyz \frac{{\partial }^{2} {V}_{m}}{\partial y \partial z} + \frac{\partial }{\partial z} gizx \frac{\partial {V}_{m}}{\partial x} + gizx \frac{{\partial }^{2} {V}_{m}}{\partial z \partial x} + \frac{\partial }{\partial z} gizy \frac{\partial {V}_{m}}{\partial y} + gizy \frac{{\partial }^{2} {V}_{m}}{\partial z \partial y} + \frac{\partial }{\partial z} gizz \frac{\partial {V}_{m}}{\partial z} + gizz \frac{{\partial }^{2} {V}_{m}}{\partial {z}^{2}} & ( 13 )\end{matrix}$$

Vₘ is the measured membrane potential and Iᵢₒₙ is the sum of all transmembrane ionic currents:

Iᵢₒₙ=I_{Na}+Iₜₒ+I_{CaL}+I_{CaNa}+I_{CaK}+I_{Kr}+I_{Ks}+I_{K1}+I_{NaCa}+I_{NaK}+I_{Nab}+I_{Cab}+I_{Kb}+I_{pCa} (14)

where the transmembrane ionic currents I_{Na} (Na+ current), Iₜₒ (transient outward K+ current), I_{CaL}(L-type Ca2+ current), I_{CaNa} (Na+ current through the L-type Ca2+ channel), I_{CaK} (K+ current through the L-type Ca2+ channel), I_{Kr} (rapid delayed rectifier K+ current), I_{Ks} (slow delayed rectifier K+ current), I_{K1} (Inward rectifier K+ current), I_{NaCa} (total Na+/Ca2+ Exchange Current), I_{NaK} (Na+/K+ ATPase Current), I_{Nab} (Na+ background current), I_{Cab} (Ca2+ background current), I_{Kb} (K+ background current), I_{pCa} (sarcolemmal Ca2+ pump current) and their parameters are given in the ORd model (O'Hara T, Virag L, Varro A, Rudy Y. Simulation of the Undiseased Human Cardiac Ventricular Action Potential: Model Formulation and Experimental Validation. PLoS Comput Biol, 2011; 7(5): e1002061 and Supplementary Materials). EQ. 9 is an elliptic partial differential equation, and EQ. 10 is a nonlinear parabolic partial differential equation. Both equations (EQs. 9 and 10) are solved by numerical analysis using the finite-difference method (FDM: Roth BJ. A comparison of two boundary conditions used with the Bidomain model of cardiac tissue. Annals Biomed Eng, 1991; 19:669-678). The data processor 110 sets up a uniform grid for each value of x, y and z at each point with space steps Δx, Δy and Δz. For uniform fiber geometry parallel to the x-axis, EQ. 7 may be written in x-y-z coordinates as partial derivatives that can be approximated using the FDM. These derivatives reduce to a linear system of equations that allows the data processor 110 to evaluate Vₑ if Vₘ and which are solved using the method of successive over-relaxation, an iterative technique. The method consists of solving for V_{ei,j} in terms of its neighbors, and then applying this equation over and over until the process converges. EQ. 8 is also approximated by a finite difference technique (Euler's method) and solved for V_{mi,j}(t+Δt) in terms of other variables at time t. Thus, if Vₘ and Vₑ are known at time t, Vₘ can be found at time t+Δt. Euler's method is explicit, which means it is subject to a stability criterion.

In summary, the data processor 110 calculates an algorithm that consists of calculating Vₘ(t+Δt) from Vₘ(t) and Vₑ(t) and then calculating Vₑ(t+Δt) from Vₑ(t) and Vₘ(t+Δt) using successive over-relaxation. When the fiber direction is not aligned with the x, y or z axis, the conductivity tensors have nonzero off-diagonal terms, g_{iLT} and g_{eLT} (L and T for x,y, and z in rotation). These add additional terms and the mixed second derivative are approximated by the FDM. In addition, when the conductivity tensors depend on position they cannot be taken outside the divergence operator, thereby introducing additional terms proportional to the derivative of the conductivity tensor and the first derivative of the potential, which are evaluated using standard central difference formulas.

Moreover, the data processor 110 determines Vₘ and Vₑ by applying the same methods described for a fiber aligned in the x-direction. The calculation also involves solving for the gate variables and ionic concentration in the ORd model. The data processor 110 solves these equations using Euler's method. During the calculation, the data processor 110 obtains values of the voltage-dependent rate constants by using linear interpolation from a lookup table built on different values of Vm, thereby reducing the number of calls to the exponential function, which appears many times in the expressions for the rate constants. The data processor 110 uses a process of iteration in accordance with the numerical analysis of the Bidomain equations with a tolerance of Vₜₒₗ=10.0 V.

For the Purkinje fibers, the data processor 110 uses the Bidomain equations with the ionic currents by Sampson et al. (Sampson K J, Iyer V, Marks A R, Kass R S. A computational model of Purkinje fibre single cell electrophysiology: implications for the long QT syndrome. J Physiol, 2010; 588(14): 2643-2655), EQ. 15. The only difference in the ionic current in EQ. 15 is the addition of 2 currents I_{CaT} and I_{Ca}:

Iᵢₒₙ=I_{Na}+Iₜₒ+I_{CaL}+I_{CaNa}+I_{CaK}+I_{Kr}+I_{Ks}+I_{K1}+I_{NaCa}+I_{NaK}+I_{Nab}+I_{Cab}+I_{Kb}+I_{pCa}+I_{CaT}+I_{Ca} (15)

The addition of I_{CaT} and I_{Ca} results in a total of 14 ionic currents described by Sampson et al., which provides features unique to Purkinje fiber cells, such as automaticity, hyperpolarized plateau potential, and prolonged action potential duration. The ORd model is based on ion channels and membrane currents in disease and therapy, such as ones imposed by genetic mutations or drug block. The model approximates human PF cellular electrophysiology using the new human gene product data. The ORd model is very sensitive to disruption of Na⁺ channel function, such as long QT syndrome type 3 and less so to other long QT genes as specific to Purkinje cell. (The model currents and channels are described by Sampson et al. and the equations are provided in the online Supplemental materials). The data processor 110 first initializes and defines all the parameters and variables, and then time loops with derivations of the ORd time dependent equations using the different currents and gates functions. The ORd model includes a total of 14 transmembrane currents/pumps, with 82 state variables for the SIMK model and 14 ionic currents and 41 state variables for ORd model. In some implementations, the data processor 110 uses a voxel having a size of (30×30×50) nodes with a space step of 100 micrometers and a time step of 20 microseconds with a run time of 500 msec (27, 80-83); however, other parameters may be used as well. An S1 stimulus of an S1-S2 protocol is activated for the whole tissue with Vm(i,j) defined as the transmembrane potential at the (i,j) node. Curving fiber terms are formulated and integrated in the program along with the fiber orientation and boundary conditions. The data processor 110 executes the first and second steps for each voxel of the whole-heart geometry using message-passing interface (MPI) for parallel computing. Once the process is complete, then the data processor 110 generates the test bench model 116 of the heart 104.

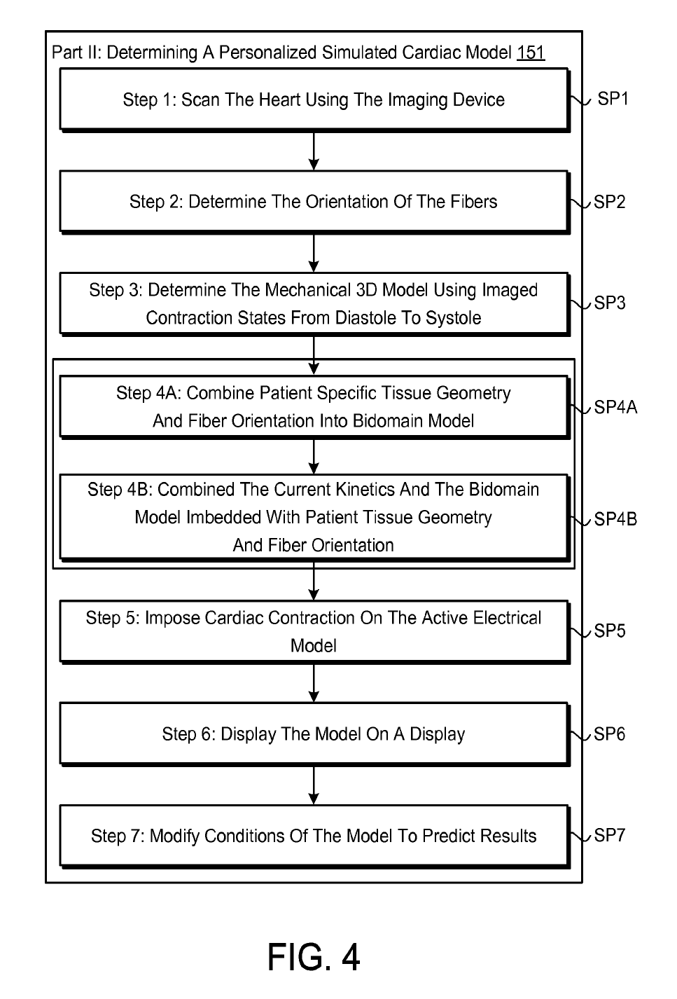

Referring to FIGS. 1 and 4, after the data processor 110 generates the test bench model 116 of the heart 104, which is based on multiple patients 102g, the data processor 110 generates a patient-specific mechanical model 150 and a simulated personalized model 151 based on images captured (by the imaging device(s) 120) of the patient 102p.

At Step SP1, of FIG. 4, the cardiac modeling system 100 begins by capturing images (e.g., imaging files 134) of the heart 104p of a target patient 102p. Referring back to FIG. 1, more than one imaging file 134, each associated with a different imaging device 120 (e.g., MRI, ECG, or ECHO) may be stored in the computer's non-transitory memory 132. In some examples, the imaging file 134 is sent to the data processor 110 after the imaging device 120 captures the image and creates the imaging file 134 via the network 140 (i.e., without being stored in the computer's non-transitory memory 132).

In some implementations, the imaging device 120 is a sheer wave imaging (SWI) device. Shear wave, also known as S-ways and secondary wave, is a type of elastic wave that moves through the body of an object. SWI is based on sheer wave propagation, which is faster along the fiber direction than across the fiber direction. The velocity of the fibers is analyzed and the fiber angle at each myocardial layer is estimated by finding a maximum shear wave speed. SWI mapping correlates well with histology in ovine hearts (r²=0.91±0.02, p<0.0001) and average fiber orientation at midsystole were found to be 71°±13° (endocardium), 27°±8° (midwall), and −26°±30° (epicardium).

In some implementations, the imaging device 120 is a speckle tracking echocardiography (STE), which analyzes the motion of tissues in the heart 104 by using ultrasonic sound waves to generate interference patterns and natural acoustic reflections (the reflections are also described as speckles markers patterns, features, or fingerprints, and they are tracked consecutively frame to frame resulting into an angle-independent two-dimensional and three-dimensional strain-base sequence). STE provides quantitative and qualitative information relating to the tissue deformation and motion. STE is used to assess myocardial structure, interrogating radial, circumferential and longitudinal deformation simultaneously. By tracking speckles, the strain, strain rate, tissue velocity and LV (Left Ventricle) rotation may be easily calculated.

In some implementations, the imaging device 120 is Cine-DENSE magnetic resonance imaging (Cine-DENSE MRI), a displacement encoding with stimulated echoes (DENSE) and is a quantitative MRI technique that encodes tissue displacement into the phase of the complex MRI images. Cine-DENSE magnetic resonance serves as a reference method in assessing myocardial radial strain (short axis), longitudinal strain (long axis), and strain rate.

In some implementations, the imaging device 120 is a transthoracic echo (e.g., Phillips IE33). The imaging device 120 obtains imaging data 134 using the X matrix probe that is acquired in the parasternal and apical views in the standard fashion with patients 102 in the left lateral position. The data processor 110 performs identification of the myocardial segments and walls in the regular echocardiographic protocol. The data processor 110 performs a cardiac ultrasound exam using a versatile X5 transducer for 3D imaging of the entire heart 104. The transducer allows switching from 2D to 3D imaging at the touch of a button to quickly integrate volume imaging into routine exams. The imaging device 120 captures images 134 of the entire heart 104 in 3D and in real time, and allows enlarging and rotating scanned volumes. After the imaging device 120 captures the images 134 (e.g., digital imaging files), the imaging device 120 sends the images to the computer 130, which in turn sends the files to the data processor 110 for post-acquisition analysis.

In some implementations, where the imaging device is a SWI, the ultrasound (US) probe of the imaging device 120 is mounted on a customized rotation device that holds the US probe centered at the circumferential-longitudinal of each plane. Shear wave images are acquired in increments of 5° counterclockwise for each short axis plane starting from a base and moving down to an apex. A total of 7 planes may be imaged for a total of 72 positions per plane of the US probe, corresponding to each angle rotated counterclockwise in increments of 5°. The imaging device 120 may acquire a total of 504 sets of images.

In some implementations, the imaging device 120 includes a programmable ultrasound system that is equipped with a conventional linear array of ultrasound probes. The programmable ultrasound system utilizes a center frequency=8 MHz, a pitch=0.2 mm, a fractional bandwidth=90%, and a pushing beam duration=120 seconds. If the imaging device 120 is a SWI, the imaging device 120 may capture images at multiple equally sampled phases in one cardiac cycle with a total acquisition time of each shear wave event at about 10 milliseconds. When the imaging device 120 is an ECG, the imaging device 120 records images at a sampling rate of 4800 Hz in synchrony with the shear wave data acquisition.

The data processor 110 receives the image file(s) 134 of the heart 104, and produces a three-dimensional mechanical representation 150 of the heart 104. At step SP2 (FIG. 4), the cardiac modeling system 100, i.e., the data processor 110, applies a fiber algorithm to the three-dimensional mechanical representation 150 to determine the orientation of the fibers within the heart 104.

Cine-Displacement Encoding with Stimulated Echoes (DENSE) is an approved technique for quantitative imaging of myocardial motion. The technique encodes tissue displacement directly into the phase of the stimulated echo images 134 relative to the onset of displacement encoding at end-diastolic reference time. With Cine DENSE data, the cardiac modeling system 100 tracks elements of myocardium through time as they move through the cardiac cycle of the heart 104. The data processor 110 uses the following stages: spatiotemporal phase unwrapping of Cine DENSE images, then material point tracking and temporal fitting of the trajectories.

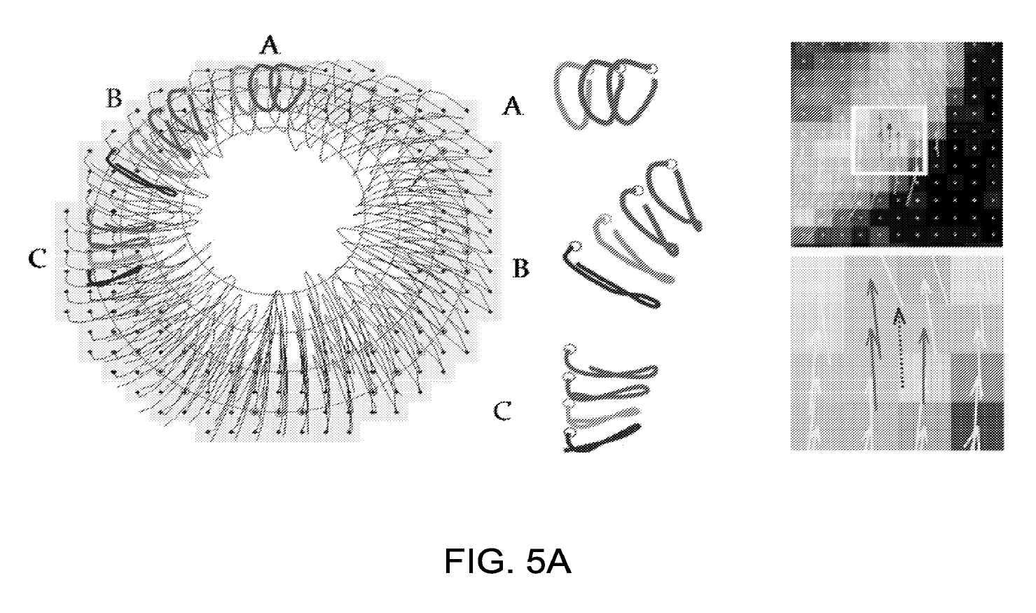

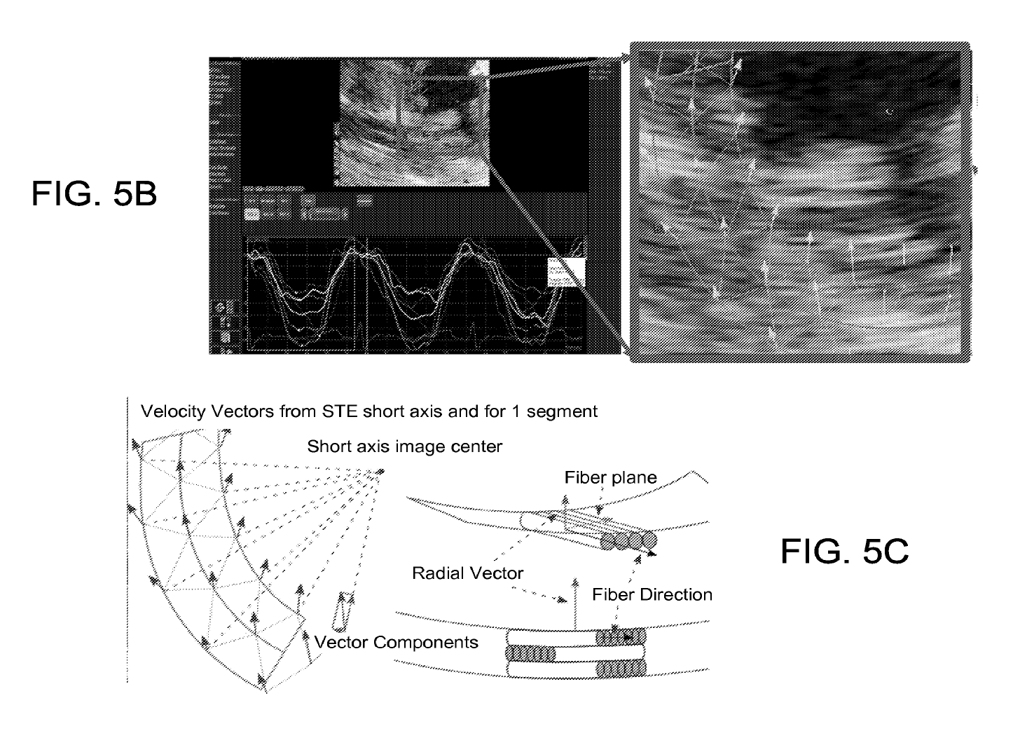

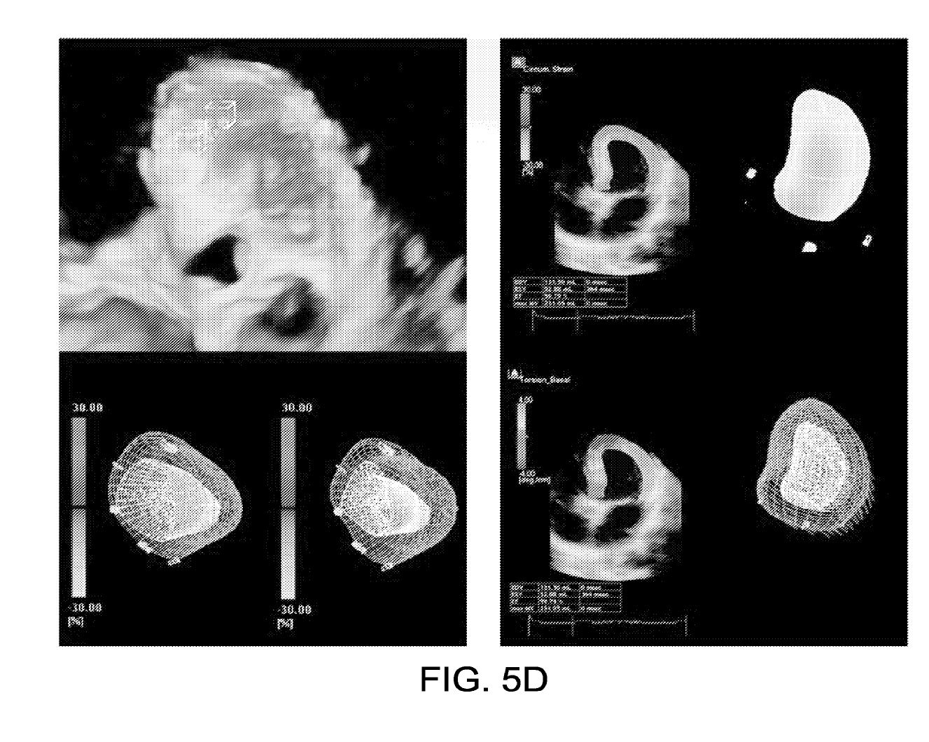

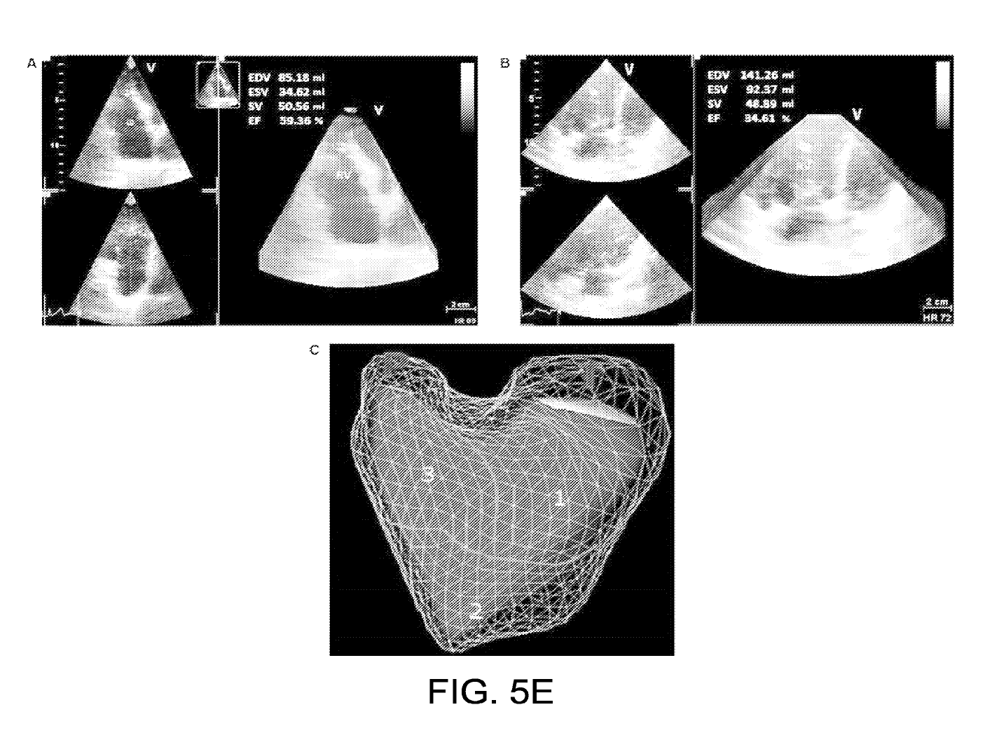

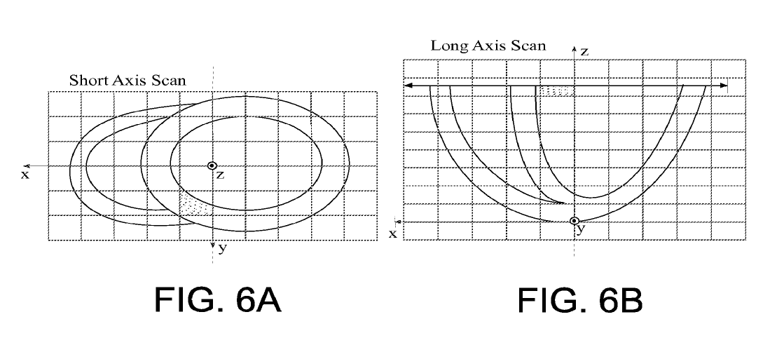

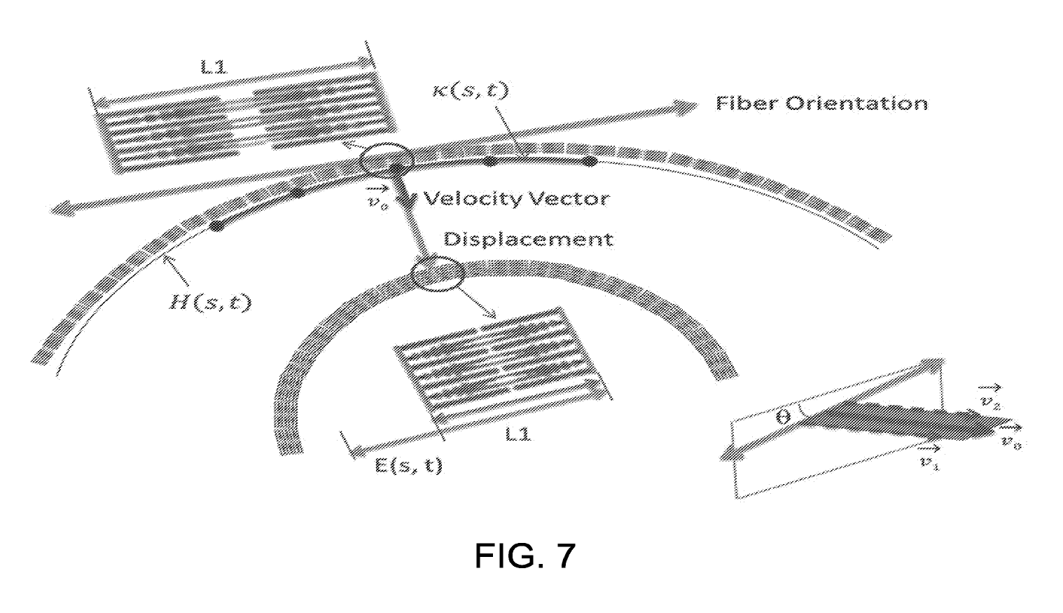

Short axis images are x-y planes along the z-axis from the heart base (i.e. “image center”, FIGS. 5A-5D). Each velocity vector has normal and tangential components. The data processor 110 uses Spline functions with matched point position to populate the segments obtained from quantification measurements using Speckle Tracking Echo. The data processor 110 applies a method of averages to determine the unknown vectors.

In some implementations, the data processor 110 uses multiple coordinate system transformation to match a final prolate spheroidal coordinate system. In some examples: 1) Cartesian coordinate system is used for raw data from DICOM files (STE and Cine-DENSE MRI); 2) Velocity vectors profile is established for segments of different sections in both short and long axis scans; 3) Splines functions are used to interpolate to all vectors tip and coordinates are estimated in different planes (x-y, x-z and y-z); and 4) Velocity profile is estimated at different times between diastolic and systolic states.

In some implementations, the data processor 110 analyses the three-dimensional simulation 150 in the global Cartesian system. All vectors are described by the position coordinates (x,y,z), an angle of orientation θ, and the magnitude ω̅, where z is a position of the short axis image. Raw data measurement from DICOM images (imaging files 134) provide segment that are approximated with cubic Splines functions.

In a first step, the data processor 110 selects two most distal (P1 and P2) points and the middle point (P0) on a line segment. Then the data processor 110 applies cubic splines to both positions at (x,y) and tip (t,p).

fₜ(x)=y (17)

where f is the cubic spline defined between points (x1,y1) and (x2,y2) at time t and found from

$$\begin{matrix}{f}_{τ} ( x ) = ( 1 - \frac{x - x 1}{x 2 - x 1} ) y 1 + ( \frac{x - x 1}{x 2 - x 1} ) y 2 + ( \frac{x - x 1}{x 2 - x 1} ) ( 1 - \frac{x - x 1}{x 2 - x 1} ) ( a ( 1 - \frac{x - x 1}{x 2 - x 1} ) + b ( \frac{x - x 1}{x 2 - x 1} ) ) & ( 18 ) \\ with & \\ a = \frac{{df}_{τ}}{dx} ( x 1 ) \times ( x 2 - x 1 ) - ( y 2 - y 1 ) & ( 19 ) \\ and & \\ b = - \frac{{df}_{τ}}{dx} ( x 2 ) \times ( x 2 - x 1 ) + ( y 2 - y 1 ) & \end{matrix}$$

Also gₜ(t)=p (20)

for the tips (t1,p1) and (t2,p2) at time t

$${g}_{τ} ( t ) = ( 1 - \frac{t - t 1}{t 2 - t 1} ) p 1 + ( \frac{t - t 1}{t 2 - t 1} ) p 2 + ( \frac{t - t 1}{t 2 - t 1} ) ( 1 - \frac{t - t 1}{t 2 - t 1} ) ( {a}^{′} ( 1 - \frac{t - t 1}{t 2 - t 1} ) + {b}^{′} ( \frac{t - t 1}{t 2 - t 1} ) ) \\ \qquad ( 21 )$$

### With

$$\begin{matrix}{a}^{′} = \frac{{dg}_{τ}}{dt} ( t 1 ) \times ( t 2 - t 1 ) - ( p 2 - p 1 ) & ( 22 ) \\ and & \\ {b}^{′} = - \frac{{dg}_{τ}}{dt} ( t 2 ) \times ( t 2 - t 1 ) + ( p 2 - p 1 ) & ( 23 )\end{matrix}$$

Each individual vector has an orientation and a magnitude as follows:

$${θ}_{i} = arctan ( \frac{p - y}{t - x} ) and ϖ = \sqrt{{( p - y )}^{2} + {( t - x )}^{2}} \qquad ( 24 )$$

This method allows the data processor 110 to populate all segments with velocity vectors at any time between diastolic and systolic phases of the heart contraction.

As shown in FIGS. 5A-5D, fiber orientation is estimated from trajectories and velocity vectors obtained from Cine-DENSE and echo measurements. Similar to an annulus made of rubber band, the myofilaments are shortened in the direction of the fiber (FIG. 7), perimeter reduction, producing a perpendicular motion, concentric contraction.

The speckle tracking of FIG. 5A is a cine-DENSE imaging of healthy volunteer 102g. Trajectories of the myocardial pixel centers for 75% of the cardiac cycle with a fifth-order Fourier basis functions fitted to raw data (left to center) and 2-D linear interpolation for few magnified pixels (right), solid vectors are used to interpolate the dotted vector.

To distinguish between myocardial layers and to approximate myocardial annulus corresponding to velocity distribution in a volume, the data processor 110 uses mathematical splines, cubic Hermitian with Bernstein polynomials of degree three, parameterized in terms of the arc length s, for each discrete time point t throughout the cardiac cycle:

H(s,t)=Σᵢ₌₀³b_{i,3}(s)β_{i,3}(t) (25)

where bi,3(s) are the Bernstein polynomials of degree three, and i, 3(s) are the Bernstein coefficients.

The Bernstein polynomials of degree three are:

b_{i,3}(x)=(ᵢ³).xⁱ.(1−x)³⁻ⁱ (26)

From this mathematical representation of the myocardial annulus, the data processor 110 extracts mechanically relevant fields, such as deformation, strain, and curvature. As shown in FIG. 7, the filaments of cardiac muscle fibers in a relaxed position (L1) and a contracted position (L2). Green-Lagrange strain E(s, t) (see FIG. 7), a relative displacement of continuum points along the annular perimeter between time t and the reference time t0, is:

E(s,t)=½[dₛH(s,t)²/dₛH(s,t₀)²−1] (27)

The curvature is determined by calculating:

$$k ( s , t ) = \frac{‖ {d}_{s} H ( s , t ) \times {d}_{S}^{2} H ( s , t ) ‖}{{‖ {d}_{s} H ( s , t ) ‖}^{3}} \qquad ( 28 )$$

where dsH(s,t) and d² sH(s,t) are first and second derivatives of the Bernstein polynomials. The data processor 110 uses the test bench model 116 that was previously determined from a population (e.g., healthy patients 104g) to match ventricular fiber layers geometry and orientations using large deformation diffeomorphic metric mapping (LDDMM). Given a model image and a patient image, respectively Ia, Ip:Ω→R where Ω⊂R3, the processor 110 using LDDMM computes a flow of diffeomorphisms φₜ^{ν}: Ω→Ω to transform Ia to match Ip, where νεL²([0,1], V):

L=(−α∇²+γ)²I_{3×3} (29)

a differential operator of the Cauchy-Navier type (and control the elasticity of the transformation) and V is a Hilbert space of smooth, compactly supported vector fields on Ω such that the evolution of a curve φₜ^{ν}:[0,1]→G(GεΩ) is determined by:

$$\frac{d}{dt} {φ}_{t}^{v} ( x ) = {v}_{t} ( {φ}_{t}^{v} ( x ) ) \qquad ( 30 )$$

The basic variational problem states that the optimal vector field is determined by:

\hat{ν}=arg min(∫₀¹∥ν_{νt}∥_{ν}²dt+1/σ²∥Iₐ^{o}φ₁⁻¹−Iₚ∥_{L}_{²}²) (31)

where ∥νt∥ is an appropriate Sobolev norm on the velocity field vt (•) and the second term enforces matching of the images (∥Iₐ^{o}φ₁⁻¹−Iₚ∥_{L2}² is a squared-error norm). (International Journal of Computer Vision February 2005, Volume 61, Issue 2, pp 139-157 Computing Large Deformation Metric Mappings via Geodesic Flows of Diffeomorphisms M. Faisal Beg, Michael I. Miller, Alain Trouvé, Laurent Younes) The data processor 110 uses Euler-Lagrange equations characterizing the minimizing vector fields and a gradient descent scheme based optimization, resulting in an optimal solution for the Large Deformation Diffeomorphic Metric Mapping (LDDMM). The data processor 110 uses the LDDMM algorithm to guarantee that transformation of the test bench model 116 preserves the integrity of the anatomical structure of the heart 104.

In some implementations, the data processor 110 determines a fiber angle from normal and shear strains for different layers. The data processor 110 uses prolate spheroidal coordinates (PSC) to localize the origin of the voxel and Cartesian coordinates (CCS) for the fiber position and orientation inside the voxel. PSC is convenient in echocardiography signal acquisition, and CCS is convenient in running the code for each voxel.

FIG. 5D shows an example of a registered speckle motion mesh reconstruction (left) that shows the velocity profile (lower right), and a “bag” representation of activation mapping (upper right). FIG. 5E shows an endocardium reconstruction and an epicardium mesh representation from a three-dimensional ECHO imaging device.

In some examples, multiple imaging devices 120 (e.g., three imaging devices, such as MRI, ECHO, and SWI) are used. Each imaging device 120 creates an imaging file 134 different than the imaging file 134 created by the other imaging devices 120. The data processor 110 utilizes imaging files 134 received from the multiple imaging devices 120 to determine the three-dimensional mechanical model 150 of the heart 104. The use of multiple imaging devices 120 (compared to only one imaging device 120) results in a higher accuracy of the test bench model 116 and the simulated personalized three-dimensional cardiac model 151, because the data processor 110 can compare the multiple imaging files 134, confirming that the data in these imaging files 134 is consistent. More imaging data may be needed if the data is not consistent.

Although the three-dimensional mechanical model, i.e. patient model 150 may suffice to understand the structural problems of a patient's heart 104, the three-dimensional mechanical model 150 does not provide sufficient data to understand the electrical behavior of the patient's heart 104. The data processor 110 reverts to the local Cartesian coordinate system for simulation analysis. All fibers in a volume element have (u,v,w) local coordinates and (θ,φ) as shown in FIG. 3.

As previously discussed, the human heart 104 includes electrical waves that cause the heart 104 to beat. These electrical waves initiate in an SA node and propagate through the entire heart 104. Therefore, to examine how the electrical waves propagate through a patient's heart 104, there is a need for an electrical model, i.e., the simulated personalized three-dimensional cardiac model 151 of the heart 104. Referring back to FIG. 4, at steps SP4A and SP4B, the data processor 110 first (at step SP4A) combines a Bidomain model and the three-dimensional mechanical model 150 determined at step SP3. Then, at step SP4B the data processor 110 combines the current kinetics with the three-dimensional mechanical model 150 determined at step SP3. A Bidomain model is a mathematical model of the electrical properties of cardiac muscle that considers both the anisotropy of the intracellular and extracellular spaces (intracellular refers to information inside the cell, while extracellular refers to information outside the cell). The domain model is a continuum model, which means that it represents the average properties of many cells. The Bidomain provides a structure of the cells of the heart 104. Therefore, the data processor 110 combines the Bidomain model and the three-dimensional mechanical model 150 (step 4A), then combines the resulting three-dimensional mechanical model 150 with additional information, which is the electrical activity of the heart 104, resulting in three-dimensional excitable or electrically active model 151. Therefore, after applying the kinetic model (e.g., Stuart model or Rudy model) the three-dimensional mechanical model 150 becomes a simulated personalized 3D model 151 of the electrical waves of the heart 104 of the target patient 102p.

Referring back to FIG. 4, at step SP5, the data processor 110 combines the cardiac contraction with the active electrical model 151 (i.e., simulated personalized 3D model 151). The step allows the data processor 110, to impose contractions of the cardiac muscle onto the imaging files 134 received from one or more imaging devices 120 (e.g., MRI, SWI, or ECHO). The contractions imposed on the active electrical model 151, are the patient's own heart contractions, i.e., patient specific contraction.

In some implementations, the physician 162 decides to view the cardiac model 151 on the computer display 160, where the cardiac model 151 only shows the electrical activity, without that hemodynamic or the amount of blood being pumped (i.e., which is step 5 showing the cardiac contractions of the heart 104).

Incorporating contraction information with the electrical dynamics model 151 (i.e., simulated personalized 3D model) is a complete overview of the simulated patient specific heart 104, because the combination of electrical and mechanical movement causes the heart 104 to pump blood into the patient body 102. Thus, for the heart 104 to pump blood, the muscle of the heart 104 has to contract, where the contraction is activated by the electrical activity. Moreover, the physician 162, while viewing the simulated personalized 3D model 151, may zoom in to the level of the cardiac contraction and view the details of the cardiac contraction.

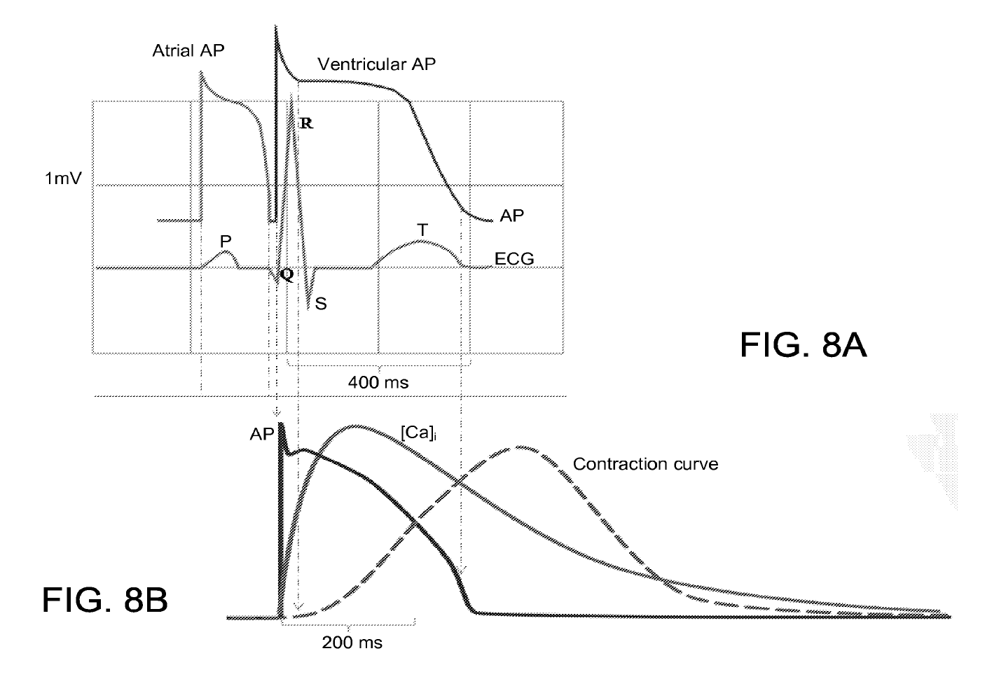

Referring to FIGS. 8A and 8B, in some implementations, the data processor 110 determines a relationship between an action potential (AP) and the contraction of the heart 104 by way of the prolate spheroidal coordinates in the global system to coordinate the activation pattern with measured contraction by repeating the above algorithm between diastolic and systolic phases to determine the contraction curve. Once the curve is established for the patient data, the cardiac activation is tuned and synchronized by changing matching variables to correspond to STE and/or Cine-DENSE MRI data.

The data processor 110 estimates the action potential (AP) from the patient specific ECG and is matched with simulation output. The data processor 110 records two AP's corresponding to atrial and ventricular contractions as shown in FIG. 8A. The PQRST corresponds to one cardiac cycle during which both atria and ventricle contract as shown. The upper graph in FIG. 8A is built from patient specific ECG with action potential generated by the simulation model. The data is recorded for more than one cycle and average amplitude and duration are selected. Then the data processor 110 determines the contraction curve to match the AP with control curve the [Ca]i transient curve generated from the mathematical model used for ventricular cells (FIG. 8B).

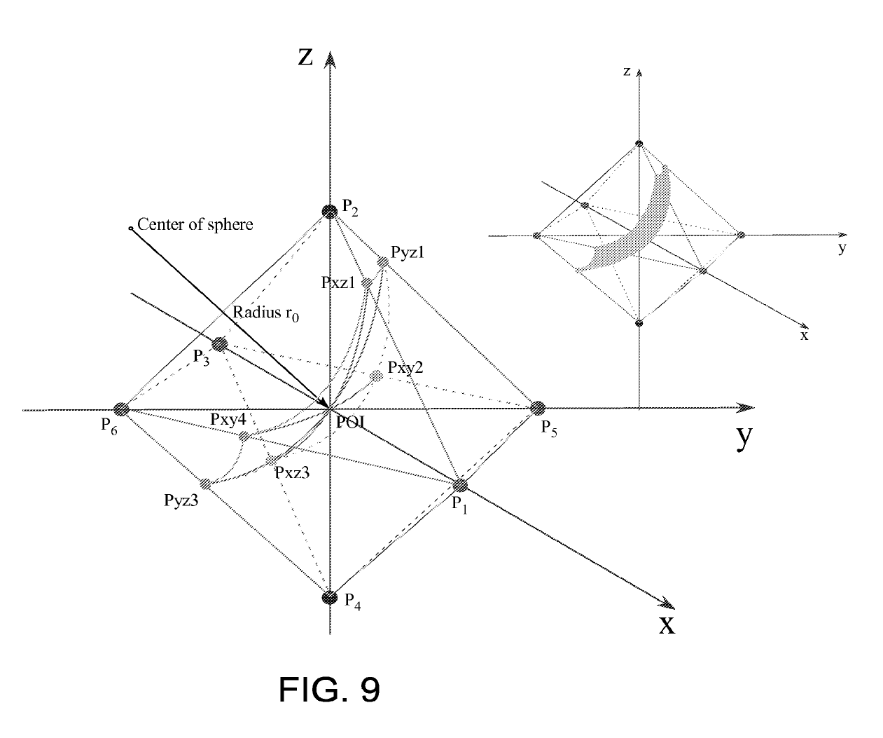

Referring to FIG. 9, the formula to incorporate contraction information with the electrical dynamics model 151 (the simulated personalized 3D model 151), i.e., to compute coordinates of points on an isochrone surface representing the 3D wavefront velocity, are as follows (note: the time-space relationship allows the simulation to tune with the contraction constraint using correction factors):

$$v = f ( θ , ϕ ) \times \frac{{\sum }_{i = 1}^{12} ( {np}_{i} \times {𝓊}_{i} )}{{\sum }_{i = 1}^{12} {np}_{i}} \qquad ( 32 )$$

where f(θ,φ) is a correction factor based on the polar angles of the radius of curvature, determined from simulation and depending on space and time steps used for the simulation. The velocity the wave front travels on each segment is

$${𝓊}_{i} = \vert \frac{b \sqrt{2}}{Δ {t}_{i}} \vert \qquad ( 33 )$$

### With,

$$\begin{matrix}Δ {t}_{i} = \{ \begin{matrix}{t}_{2} - {t}_{1} for segment i = 1 \\ {t}_{2} - {t}_{5} for segment i = 2 \\ {t}_{2} - {t}_{3} for segment i = 3 \\ {t}_{2} - {t}_{6} for segment i = 4\end{matrix} & ( 34 A ) \\ Δ {t}_{i} = \{ \begin{matrix}{t}_{5} - {t}_{1} for segment i = 5 \\ {t}_{3} - {t}_{5} for segment i = 6 \\ {t}_{6} - {t}_{3} for segment i = 7 \\ {t}_{1} - {t}_{6} for segment i = 8\end{matrix} & ( 34 B ) \\ Δ {t}_{i} = \{ \begin{matrix}{t}_{4} - {t}_{1} for segment i = 9 \\ {t}_{4} - {t}_{5} for segment i = 10 \\ {t}_{4} - {t}_{3} for segment i = 11 \\ {t}_{4} - {t}_{6} for segment i = 12\end{matrix} \\ and , & ( 34 C ) \\ {np}_{i} = \{ \begin{matrix}0 if {t}_{0} ∉ [ time segment i ] \\ 1 if {t}_{0} ∉ [ time segment i ]\end{matrix} & ( 34 D )\end{matrix}$$

t₀ being the time the wavefront arrives at the point of interest (POI) and tᵢ the time the wavefront arrives at point Pᵢ. Points Pij are position wavefront reaches on segment (i,j) at time t₀. Time ratios are used to determine the coordinates of the points. For example the wavefront would have reach Pxz1 (on the x-z plane quadrant I) at time t₀ while reaching the POI. With b being the space step, the coordinates of Pxz1 are:

$$x = \frac{{t}_{0} - {t}_{2}}{{t}_{1} - {t}_{2}} \times b \qquad ( 35 A )$$

y=0 (35B)

$$z = \frac{{t}_{1} - {t}_{0}}{{t}_{1} - {t}_{2}} \times b \qquad ( 35 C )$$

The radius of curvature is determined using the equations of the sphere with any four points the wavefront reaches at time t₀ using the determinant described by Beyer (Beyer, W. H. (Ed.) CRC Standard Mathematical Tables, 28th ed. Boca Raton, Fla.: CRC Press, 1987).

The relationship between wavefront determination and arrival times allows for synchronization of the contraction constraint by changing space and time variable of the correction factor.

With the spatial deformation of the elements of volume, the simulation can be tuned so that the activation produces the same contraction, similar to the conduction velocities that the cardiac activation follows within the conduction pathways.

Therefore, the 3-D simulation model 151 is complete after step SP5, and the data processor 110 sends the 3D simulation model 151 to the display 160 (Step SP6). In some embodiments, finite element analysis is used so that the 3D simulation model can be visualized on the display. The simulation model 151 includes information captured by the imaging device(s) 120. Therefore, a physician 162 may manipulate the 3-D simulation model 151 to simulate certain conditions of the heart 104 (step SP7). For example, by simulating the removal of a mass within the heart 104 that was detected by the imaging device 120. The physician 162 is capable of simulating certain conditions that he may analyze visually before physically altering state of the heart 104 of the target patient 102p via surgical procedure, for example. The physician 162 may change multiple conditions, i.e. testing multiple solutions before implementation on the patient's heart 104. By modifying certain parameters the simulation provides a predictive assessment of conditions that the physician 162 wants to create. The physician 162 may modify the cardiac model 151 by the mechanical i.e. structural level, or at the electrical level. Therefore, if there is a mass blocking an electrical path, the physician 162 may remove the mass on the 3D cardiac simulation model 151 and observe how the simulated model 151 behaves, which would be a representation of how the human heart 104 would behave. Moreover, an electrical modification of the simulated personalized three-dimensional cardiac model 151 may include a change in the ionic concentration, speeds of the electrical propagation, or other variables relating to the electrical propagation. As an example, if the doctor 162 suspects that the problem causing the heart condition is a high potassium number, the physician 162 may introduce a drug that may lower the potassium value, and determine via the cardiac model 151 if the problem was corrected.

As shown in FIG. 1, The data processor 110 modifies the cardiac simulated model 151 based on the simulated condition 172 (received by the input device 170 from a physician 162) and after modifying the cardiac model 151 based on the simulated condition 172, the data processor 110 sends the updated 3D simulated model 151 to the display 160 to be viewed by the physician 162. The physician 162 may make additional simulated conditions 172, and the data processor 110 readjusts the cardiac model 151 based on the additional simulated conditions 172. In some examples, the data processor 110 is capable of updating the 3D simulated model 151 in real time.

The physician 162 may view the visual representation 152 of the simulated personalized three-dimensional cardiac model 151 on the display 160. The cardiac representation 152 of the cardiac model 151 may show a masse(s) in the myocardium. The physician 162 may be able to view the masses on the display 160. The physician 162 may also be able to excite the cardiac model 151 by applying a simulated electrical pulse and see how the cardiac model 151 responds to the simulated electrical pulse. If the cardiac model 151 responds unfavorably to a simulated electrical pulse then the physician 162 may simulate a surgical procedure or the medication before actually performing the procedure of administering the medication. The computer 130 and/or the data processor 110 modify the cardiac model 151 based on the simulated condition 172 of and show and display the impact of the simulated condition 172 of the cardiac model 151. For example, if the physician 162 removes a mass in the myocardium of the simulated personalized three-dimensional cardiac model 151 via the input device 170, then the physician 162 can see how the electrical activity may change after the mass is removed.

The cardiac modeling system 100 may include a defibrillator 180. The defibrillator 180 may be an implantable defibrillator that is implanted inside the patient 102. The defibrillator 180 may have a defibrillator threshold 182. The defibrillator threshold 182 may include voltage values and time durations. The voltage values may indicate an amount of voltage that is applied to the patient 102. Time durations may indicate an amount of time for which that voltage is applied to the patient 102. Some patients 102 may be vulnerable to certain voltage ranges. In some examples, the simulated personalized three-dimensional cardiac model 151 of the patient 102 indicates whether the patient 102 is vulnerable to certain voltage ranges. The cardiac model 151 of the patient 102 may also indicate a safe voltage range for the patient 102. Further, the cardiac model 151 may indicate a time duration for which voltage may be safely applied to the patient 102. The computer 130 may use the simulated personalized three-dimensional cardiac model 151 to determine the defibrillator threshold 182. For example, the computer 130 may set a maximum voltage the defibrillator 180 that can be applied to the patient 102. Similarly the computer 130 may configure the defibrillator 180 to limit the time duration of the shock that the defibrillator 180 may apply to the patient 102. Although in the example of FIG. 1, the computer 130 configures defibrillator threshold 182 of the defibrillator 180 in other examples the computer 130 may configure a pacemaker threshold off a pacemaker that may be implanted inside patient 102.

The unique representation of the myocardium structure may represent the “fingerprint” of the whole-heart, i.e., its digital signature. The data processor 110 and the physician 162 may correlate simulation and clinical measurements of critical values guiding defibrillation calibration of internal cardioverter defibrillator (ICD) and the pacemaker.

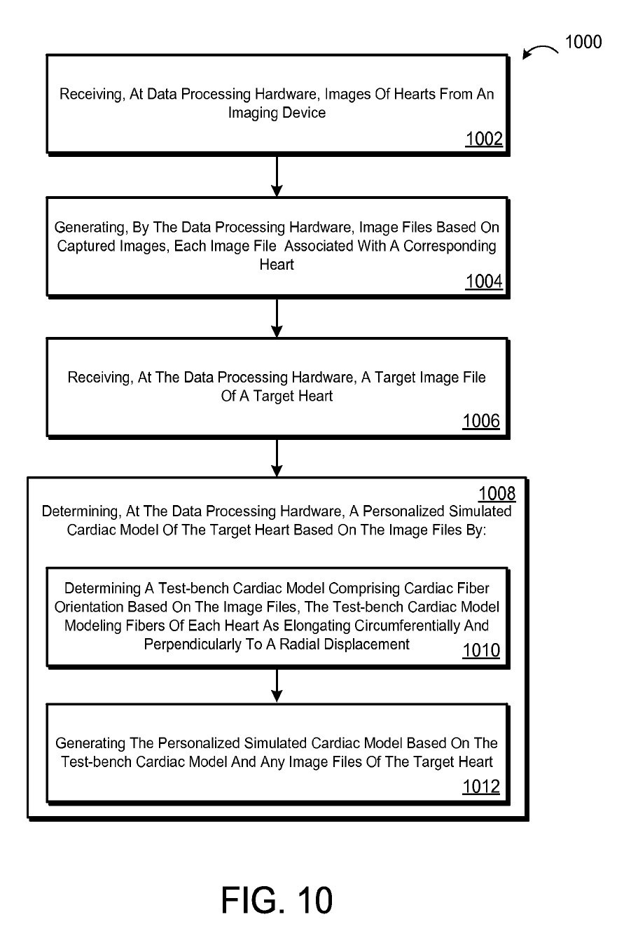

FIG. 10 provides an example arrangement of operations for a method 1000 of determining a personalized simulated cardiac model 151 of the heart 104p of the target patient 102p. At block 1002, the method 1000 includes receiving, at data processing hardware 112, 138, images 133 of multiple hearts 104g from an imaging device 120. At block 1004, the method includes generating, by the data processing hardware 112, 138, image files 134g based on the captured images 133. In some examples, each image file 134g is associated with a corresponding heart of a patient. In addition, at block 1006, the method 1000 includes receiving, at the data processing hardware 112, 138, a target image 134p file of a target heart 104p. At block 1008, the method 1000 includes determining, at the data processing hardware 112, 138, a personalized simulated cardiac model 151 of the target heart based on the image files 134g. Where block 1008 is determined by blocks 1010 and 1012. At block 1010, the method 1000 includes determining a test-bench cardiac model 116 that includes cardiac fiber orientation based on the image files 134g. The test-bench model cardiac model 116 modeling fibers of each hear 134g as elongating circumferentially and perpendicularly to a radial displacement. At block 1012, the method 1000 includes generating the personalized simulated cardiac model 151 based on the test-bench cardiac model 116 and image files 134p of the target heart 104pe.

In some examples, the method 100 includes sending, from the data processing hardware 112, 138, the personalized simulated cardiac model 151 to a display 160 in communication with the data processing hardware 112, 138 for rending in a graphical user interface. The rendered personalized simulated cardiac model may have at least one user selectable portion that upon selection, allows customization of the personalized simulated cardiac model 151. The imaging device 120 may include one or more of a Magnetic Resonance Imaging (MRI) device, an echocardiogram, and a sheer wave imaging device. In some examples, the method 1000 includes receiving, at the data processing hardware 112, 138, speckle data from the imaging device 120. The speckle data may include at least one of speckle strain and speckle velocity. The method 1000 may also include determining, at the data processing hardware 112, 138, the cardiac fiber orientation by selecting two most distal points (P1 and P2) and a middle point (P0), and applying cubic splines to the points (selected from segments as shown in FIG. 5C).

In some implementations, the method 1000 further includes generating, at the data processing hardware 112, 138, a mechanical cardiac model 150 based on the test-bench model 116 by: 1) generating a plurality of voxels with cardiac fibers oriented in a predetermined direction; 2) modifying the orientation of the cardiac fibers in each voxel to represent the cardiac fiber orientation determined based on the speckle data; and 3) combining the plurality of voxels to generate the mechanical cardiac model 150. Combining the plurality of voxels may include applying finite element analysis on the plurality of voxels. In some examples, the method 1000 includes generating, at the data processing hardware 112, 138, the personalized simulated cardiac model 151 by: 1) implementing a Bidomain model in the mechanical cardiac model 150) to represent cardiac tissue as a continuum; and 2) implementing current kinetics in the Bidomain model to emulate ionic channels and flow of ions in the cardiac tissue. Implementing the Bidomain model, may include solving Bidomain equations through discretization and constant iteration.

The method 1000 may also include receiving, at the, cardiac contraction data of the target patient 102p, and imposing, at the data processing hardware 112, 138, cardiac contraction constraints on the mechanical cardiac model 150 to personalize the mechanical cardiac model 150 to match the cardiac contractions of the patient 102p. The cardiac contraction data includes at least one of a length of contraction and a length of expansion. The method 1000 may also include receiving, at the data processing hardware 112, 138, the cardiac contraction data from one or more of a Magnetic Resonance Imaging device, an echocardiogram, and a sheer wave imaging device 120.

In some implementation, the method 1000 includes imposing, at data processing hardware 112, 138, cardiac contraction constraints by calculating EQs. 32-35C. Additionally, the method may include displaying, on a display 160 in communication with the data processing hardware 112, 138, personalized simulated cardiac model 151. The method 1000 may also include receiving, via an input device 170 in communication with the data processing hardware 112, 138, an input regarding a simulated condition; modifying, at the data processing hardware 112, 138, the personalized simulated cardiac model 151 based on the input regarding the simulated condition; and sending, from the data processing hardware 112, 138, the modified personalized simulated cardiac model 151 to the display 160. The method 1000 may also include displaying, on the display 160 modified personalized simulated cardiac model 151.

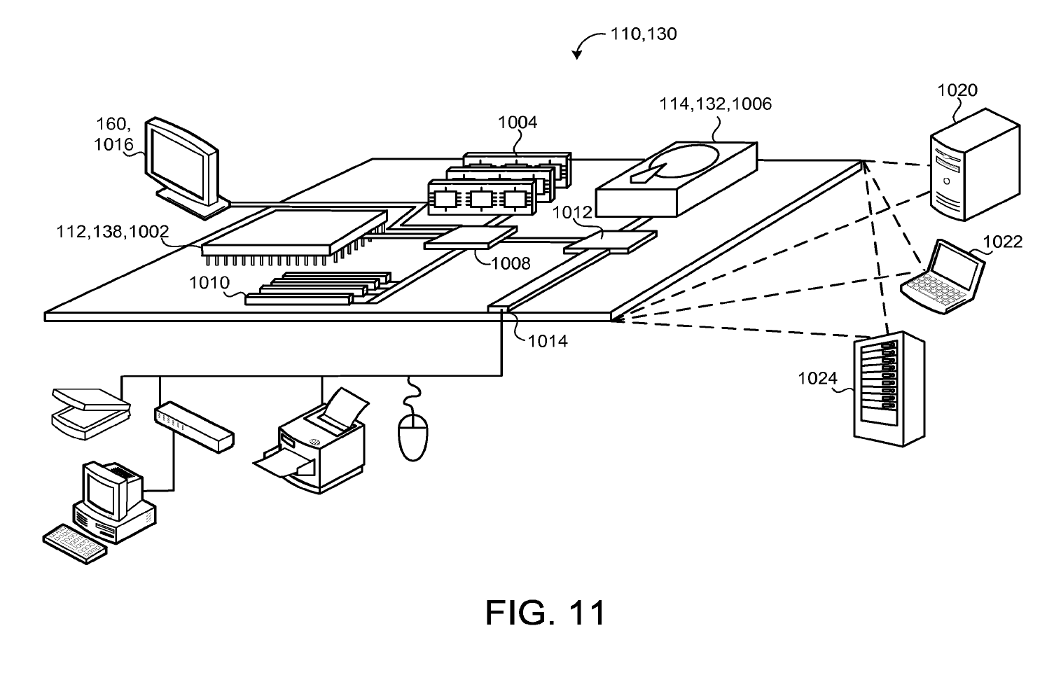

FIG. 11 is a block diagram of an example computing device 110, 130 that may be used to implement the systems and methods described in this document. The computing device 110, 130 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 110, 130 includes a processor 112, 138, 1102, memory 1104, a storage device 114, 132, 1106, a high-speed interface 1108 connecting to memory 1104 and high-speed expansion ports 1110, and a low speed interface 1112 connecting to low speed bus 1114 and storage device 114, 132, 1006. Each of the components 1102, 1104, 1106, 1108, 1110, and 1112, are interconnected using various busses, and may be mounted on a common motherboard or in other manners as appropriate. The processor 112, 138, 1102 can process instructions for execution within the computing device 110, 130, including instructions stored in the memory 1104 or on the storage device 114, 132, 1106 to display graphical information for a graphical user interface (GUI) on an external input/output device, such as display 1116 coupled to high speed interface 1108. In other implementations, multiple processors and/or multiple buses may be used, as appropriate, along with multiple memories and types of memory. Also, multiple computing devices 110, 130 may be connected, with each device providing portions of the necessary operations (e.g., as a server bank, a group of blade servers, or a multi-processor system).

The memory 1104 stores information within the computing device 110, 130. In one implementation, the memory 1104 is a computer-readable medium. In one implementation, the memory 1104 is a volatile memory unit or units. In another implementation, the memory 1104 is a non-volatile memory unit or units.

The storage device 114, 132, 1106 is capable of providing mass storage for the computing device 110, 130. In some implementations, the storage device 114, 132, 1106 is a computer-readable medium. In various different implementations, the storage device 114, 132, 1106 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 1104, the storage device 114, 132, 1106, or memory on processor 112, 138, 1102.

The high speed controller 1108 manages bandwidth-intensive operations for the computing device 110, 130, while the low speed controller 1112 manages lower bandwidth-intensive operations. Such allocation of duties is exemplary only. In some implementations, the high-speed controller 1108 is coupled to memory 1104, display 160, 1116 (e.g., through a graphics processor or accelerator), and to high-speed expansion ports 1110, which may accept various expansion cards (not shown). In the implementation, low-speed controller 1112 is coupled to storage device 114, 132, 1106 and low-speed expansion port 1114. The low-speed expansion port 1114, which may include various communication ports (e.g., USB, Bluetooth, Ethernet, wireless Ethernet) may be coupled to one or more input/output devices, such as a keyboard, a pointing device, a scanner, or a networking device, such as a switch or router, e.g., through a network adapter.

The computing device 110, 130 may be implemented in a number of different forms, as shown in the figure. For example, it may be implemented as a standard server 1120, or multiple times in a group of such servers. It may also be implemented as part of a rack server system 1124. In addition, it may be implemented in a personal computer, such as a laptop computer 1122. Alternatively, components from computing device 110, 130 may be combined with other components in a mobile device (not shown). Each of such devices may contain one or more of computing device 110, 130 and an entire system may be made up of multiple computing devices 110, 130 communicating with each other.

Various implementations of the systems and techniques described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

1. A cardiac modeling system comprising:
an imaging device configured to:
capture images of hearts; and
generate image files based on the captured images, each image file associated with a corresponding heart; and
a data processing device in communication with the imaging device and configured to determine a personalized simulated cardiac model of a target heart based on the image files by:
determining a test-bench cardiac model of cardiac fiber orientation based on the image files, the test-bench cardiac model modeling fibers of each heart as elongating circumferentially and perpendicularly to a radial displacement; and
generating the personalized simulated cardiac model based on the test-bench cardiac model and one or more of the image files associated with the target heart.

2. The cardiac modeling system of claim 1, wherein the data processing device is configured to send the personalized simulated cardiac model to a display in communication with the data processing device for rendering in a graphical user interface, the rendered personalized simulated cardiac model having at least one user selectable portion, that upon selection, allows customization of the personalized simulated cardiac model.

3. The cardiac modeling system of claim 1, wherein the imaging device includes one or more of a Magnetic Resonance Imaging (MRI) device, an echocardiogram, and a sheer wave imaging device, and wherein the data processing device is configured to receive speckle data from the imaging device.

4. The cardiac modeling system of claim 3, wherein the speckle data comprises at least one of speckle strain and speckle velocity.

5. The cardiac modeling system of claim 3, wherein the data processing device determines the cardiac fiber orientation by:
selecting two most distal points and a middle point on a line segment; and
applying cubic splines to both position (x,y) and tip (t,p)
fₜ(x)=y
where f is the cubic spline defined between points (x1,y1) and (x2,y2) at time t and determined as:
$${f}_{τ} ( x ) = ( 1 - \frac{x - x 1}{x 2 - x 1} ) y 1 + ( \frac{x - x 1}{x 2 - x 1} ) y 2 + ( \frac{x - x 1}{x 2 - x 1} ) ( 1 - \frac{x - x 1}{x 2 - x 1} ) ( a ( 1 - \frac{x - x 1}{x 2 - x 1} ) + b ( \frac{x - x 1}{x 2 - x 1} ) ) \\ with \\ a = \frac{{df}_{τ}}{dx} ( x 1 ) \times ( x 2 - x 1 ) - ( y 2 - y 1 ) and \\ b = \frac{{df}_{τ}}{dx} ( x 2 ) \times ( x 2 - x 1 ) + ( y 2 - y 1 ) \qquad ( 18 )$$
with gₜ(t)=p
for the tips (t1,p1) and (t2,p2) at time t
$${g}_{τ} ( t ) = ( 1 - \frac{t - t 1}{t 2 - t 1} ) p 1 + ( \frac{t - t 1}{t 2 - t 1} ) p 2 + ( \frac{t - t 1}{t 2 - t 1} ) ( 1 - \frac{t - t 1}{t 2 - t 1} ) ( {a}^{′} ( 1 - \frac{t - t 1}{t 2 - t 1} ) + {b}^{′} ( \frac{t - t 1}{t 2 - t 1} ) ) \\ with \\ {a}^{′} = \frac{{dg}_{τ}}{dt} ( t 1 ) \times ( t 2 - t 1 ) - ( p 2 - p 1 ) and \\ {b}^{′} = \frac{{dg}_{τ}}{dt} ( t 2 ) \times ( t 2 - t 1 ) + ( p 2 - p 1 ) \qquad ( 21 )$$
and each individual vector having orientation and magnitude as follows:
$${θ}_{i} = arctan ( \frac{p - y}{t - x} )$$
and ω̅=\sqrt{(p−y)²+(t−x)²}.

6. The cardiac modeling system of claim 3, wherein the data processing device is configured to generate a mechanical cardiac model based on the test-bench model by:
generating a plurality of voxels with cardiac fibers oriented in a predetermined direction;
modifying the orientation of the cardiac fibers in each voxel to represent the cardiac fiber orientation determined based on the speckle data; and
combining the plurality of voxels to generate the mechanical cardiac model.

7. The cardiac modeling system of claim 6, wherein combining the plurality of voxels comprises applying finite element analysis on the plurality of voxels.

8. The cardiac modeling system of claim 6, wherein the data processing device is configured to generate the personalized simulated cardiac model by:
implementing a Bidomain model in the mechanical cardiac model to represent cardiac tissue as a continuum; and
implementing current kinetics in the Bidomain model to emulate ionic channels and flow of ions in the cardiac tissue.

9. The cardiac modeling system of claim 8, wherein implementing the Bidomain model comprises solving Bidomain equations through discretization and constant iteration.

10. The cardiac modeling system of claim 8, wherein the data processing device is configured to:
receive cardiac contraction data from image files of the target heart; and
impose cardiac contraction constraints on the mechanical cardiac model to personalize the mechanical cardiac model to match the cardiac contractions of the target heart.

11. The cardiac modeling system of claim 10, wherein the cardiac contraction data comprises at least one of a length of contraction and a length of expansion.

12. The cardiac modeling system of claim 10, wherein the data processing device is configured to receive the cardiac contraction data from one or more of a Magnetic Resonance Imaging device, an echocardiogram, and a sheer wave imaging device.

13. The cardiac modeling system of claim 10, wherein the one or more data processing devices imposes cardiac contraction constraints by calculating:
$$v = f ( θ , ϕ ) \times \frac{{\sum }_{i = 1}^{12} ( {np}_{i} \times {u}_{i} )}{{\sum }_{i = 1}^{12} {np}_{i}}$$
where f(θ,φ) is a correction factor based on polar angles of a radius of curvature, determined from simulation and depending on space and time steps used for the simulation, and a velocity of a wavefront that travels on each segment is:
$${u}_{i} = \vert \frac{b \sqrt{2}}{Δ {t}_{i}} \vert$$
$$with$$
$$Δ {t}_{i} = \{ \begin{matrix}{t}_{2} - {t}_{1} for segment i = 1 \\ {t}_{2} - {t}_{5} for segment i = 2 \\ {t}_{2} - {t}_{3} for segment i = 3 \\ {t}_{2} - {t}_{6} for segment i = 4\end{matrix} \\ Δ {t}_{i} = \{ \begin{matrix}{t}_{5} - {t}_{1} for segment i = 5 \\ {t}_{3} - {t}_{5} for segment i = 6 \\ {t}_{6} - {t}_{3} for segment i = 7 \\ {t}_{1} - {t}_{6} for segment i = 8\end{matrix} \\ Δ {t}_{i} = \{ \begin{matrix}{t}_{4} - {t}_{1} for segment i = 9 \\ {t}_{4} - {t}_{5} for segment i = 10 \\ {t}_{4} - {t}_{3} for segment i = 11 \\ {t}_{4} - {t}_{6} for segment i = 12\end{matrix} \\ and , \\ {np}_{i} = \{ \begin{matrix}0 & if {t}_{0} ∉ [ time segment i ] \\ 1 & if {t}_{0} ∈ [ time segment i ]\end{matrix}$$
t₀ being the time the wavefront arrives at a point of interest (POI) and tᵢ the time the wavefront arrives at point Pᵢ, with b being the space step, and coordinates of Pxz1 are
$$x = \frac{{t}_{0} - {t}_{2}}{{t}_{1} - {t}_{2}} \times b$$
y=0
$$z = \frac{{t}_{1} - {t}_{0}}{{t}_{1} - {t}_{2}} \times b .$$

14. The cardiac modeling system of claim 8, further comprising:
a display;
a network interface for communicating with the data processing device over a network; and
a data processing hardware in communication with display and the network interface, wherein the data processing hardware is configured to:
receive the personalized simulated cardiac model from the data processing device; and
display personalized simulated cardiac model on the display.

15. The cardiac modeling system of claim 14, further comprising an input device in communication with the data processing hardware and display, wherein the data processing hardware receives, via the input device, an input regarding a simulated condition, and wherein the data processing hardware is configured to:
modify the personalized simulated cardiac model based on the input regarding the simulated condition; and
send the modified personalized simulated cardiac model to the data processing hardware.

16. The cardiac modeling system of claim 15, wherein the display displays the modified three-dimensional cardiac model on the display.

17. The cardiac modeling system of claim 15, wherein:
the input regarding the simulated condition comprises a command to remove a mass; and
the data processing hardware is configured to modify the personalized simulated cardiac model by removing a representation of the mass from the personalized simulated cardiac model.

18. The cardiac modeling system of claim 15, wherein:
the input regarding the simulated condition comprises administering a medication that alters ion concentration in a cardiac muscle; and
the data processing hardware is configured to modify the personalized simulated cardiac model by modifying the current kinetics to alter at least one ionic channel and the flow of ions in the ionic channel.

19. A method comprising:
receiving, at data processing hardware, images of hearts from an imaging device;
generating, by the data processing hardware, image files based on captured images, each image file associated with a corresponding heart;
receiving, at the data processing hardware, a target image file of a target heart; and
determining, at the data processing hardware, a personalized simulated cardiac model of the target heart based on the image files by:
determining a test-bench cardiac model comprising cardiac fiber orientation based on the image files, the test-bench cardiac model modeling fibers of each heart as elongating circumferentially and perpendicularly to a radial displacement; and
generating the personalized simulated cardiac model based on the test-bench cardiac model and any image files of the target heart.

20. The method of claim 19, further comprising, sending, from the data processing hardware, the personalized simulated cardiac model to a display in communication with the data processing hardware for rendering in a graphical user interface, the rendered personalized simulated cardiac model having at least one user selectable portion, that upon selection, allows customization of the personalized simulated cardiac model.

21. The method of claim 19, further comprising receiving, at the data processing hardware, speckle data from the imaging device, the imaging device including one or more of a Magnetic Resonance Imaging (MRI) device, an echocardiogram, and a sheer wave imaging device.

22. The method of claim 21, wherein the speckle data comprises at least one of speckle strain and speckle velocity.

23. The method of claim 21, further comprising determining, at the data processing hardware, the cardiac fiber orientation by:
selecting two most distal points and a middle point on a line segment; and
applying cubic splines to both position (x,y) and tip (t,p)
fₜ(x)=y
where f is the cubic spline defined between points (x1,y1) and (x2,y2) at time t and determined by:
$${f}_{τ} ( x ) = ( 1 - \frac{x - x 1}{x 2 - x 1} ) y 1 + ( \frac{x - x 1}{x 2 - x 1} ) y 2 + ( \frac{x - x 1}{x 2 - x 1} ) ( 1 - \frac{x - x 1}{x 2 - x 1} ) ( a ( 1 - \frac{x - x 1}{x 2 - x 1} ) + b ( \frac{x - x 1}{x 2 - x 1} ) ) \\ with \\ a = \frac{{df}_{τ}}{dx} ( x 1 ) \times ( x 2 - x 1 ) - ( y 2 - y 1 ) and \\ b = \frac{{df}_{τ}}{dx} ( x 2 ) \times ( x 2 - x 1 ) + ( y 2 - y 1 ) \qquad ( 18 )$$
with gₜ(t)=p
for the tips (t1,p1) and (t2,p2) at time t
$${g}_{τ} ( t ) = ( 1 - \frac{t - t 1}{t 2 - t 1} ) p 1 + ( \frac{t - t 1}{t 2 - t 1} ) p 2 + ( \frac{t - t 1}{t 2 - t 1} ) ( 1 - \frac{t - t 1}{t 2 - t 1} ) ( {a}^{′} ( 1 - \frac{t - t 1}{t 2 - t 1} ) + {b}^{′} ( \frac{t - t 1}{t 2 - t 1} ) ) \\ with \\ {a}^{′} = \frac{{dg}_{τ}}{dt} ( t 1 ) \times ( t 2 - t 1 ) - ( p 2 - p 1 ) and \\ {b}^{′} = \frac{{dg}_{τ}}{dt} ( t 2 ) \times ( t 2 - t 1 ) + ( p 2 - p 1 ) \qquad ( 21 )$$
and each individual vector having orientation and magnitude as follows:
$${θ}_{i} = arctan ( \frac{p - y}{t - x} )$$
and ω̅=\sqrt{(p−y)²+(t−x)²}.

24. The method of claim 21, further comprising generating, at the data processing hardware, a mechanical cardiac model based on the test-bench model by:
generating a plurality of voxels with cardiac fibers oriented in a predetermined direction;
modifying the orientation of the cardiac fibers in each voxel to represent the cardiac fiber orientation determined based on the speckle data; and
combining the plurality of voxels to generate the mechanical cardiac model.

25. The method of claim 24, wherein combining the plurality of voxels comprises applying finite element analysis on the plurality of voxels.

26. The method of claim 24, further comprising generating, at the data processing hardware, the personalized simulated cardiac model by:
implementing a Bidomain model in the mechanical cardiac model to represent cardiac tissue as a continuum; and
implementing current kinetics in the Bidomain model to emulate ionic channels and flow of ions in the cardiac tissue.

27. The method of claim 26, wherein implementing the Bidomain model comprises solving Bidomain equations through discretization and constant iteration.

28. The method of claim 26, further comprising:
receiving, at the data processing hardware, cardiac contraction data of the target heart; and
imposing, at the data processing hardware, cardiac contraction constraints on the mechanical cardiac model to personalize the mechanical cardiac model to match the cardiac contractions of the target heart.

29. The method of claim 28, wherein the cardiac contraction data comprises at least one of a length of contraction and a length of expansion.

30. The method of claim 28, further comprising receiving, at the data processing hardware, the cardiac contraction data from one or more of a Magnetic Resonance Imaging device, an echocardiogram, and a sheer wave imaging device.

31. The method of claim 28, further comprising imposing, at the data processing hardware, cardiac contraction constraints ν by calculating:
$$v = f ( θ , ϕ ) \times \frac{{\sum }_{i = 1}^{12} ( {np}_{i} \times {u}_{i} )}{{\sum }_{i = 1}^{12} {np}_{i}}$$
where f(θ,φ) is a correction factor based on polar angles of a radius of curvature, determined from simulation and depending on space and time steps used for the simulation, and a velocity of a wavefront that travels on each segment is:
$${u}_{i} = \vert \frac{b \sqrt{2}}{Δ {t}_{i}} \vert$$
$$with$$
$$Δ {t}_{i} = \{ \begin{matrix}{t}_{2} - {t}_{1} for segment i = 1 \\ {t}_{2} - {t}_{5} for segment i = 2 \\ {t}_{2} - {t}_{3} for segment i = 3 \\ {t}_{2} - {t}_{6} for segment i = 4\end{matrix} \\ Δ {t}_{i} = \{ \begin{matrix}{t}_{5} - {t}_{1} for segment i = 5 \\ {t}_{3} - {t}_{5} for segment i = 6 \\ {t}_{6} - {t}_{3} for segment i = 7 \\ {t}_{1} - {t}_{6} for segment i = 8\end{matrix} \\ Δ {t}_{i} = \{ \begin{matrix}{t}_{4} - {t}_{1} for segment i = 9 \\ {t}_{4} - {t}_{5} for segment i = 10 \\ {t}_{4} - {t}_{3} for segment i = 11 \\ {t}_{4} - {t}_{6} for segment i = 12\end{matrix} \\ and , \\ {np}_{i} = \{ \begin{matrix}0 & if {t}_{0} ∉ [ time segment i ] \\ 1 & if {t}_{0} ∈ [ time segment i ]\end{matrix}$$
t₀ being the time the wavefront arrives at a point of interest (POI) and tᵢ the time the wavefront arrives at point Pᵢ, with b being the space step, and
coordinates (x,y,z) of Pxz1 are
$$x = \frac{{t}_{0} - {t}_{2}}{{t}_{1} - {t}_{2}} \times b$$
y=0
$$z = \frac{{t}_{1} - {t}_{0}}{{t}_{1} - {t}_{2}} \times b .$$

32. The method of claim 31, further comprising:
displaying, on a display in communication with the co data processing hardware, personalized simulated cardiac model.

33. The method of claim 32, further comprising:
receiving, via an input device in communication with the data processing hardware, an input regarding a simulated condition;
modifying, at the data processing hardware, the personalized simulated cardiac model based on the input regarding the simulated condition; and
sending, at the data processing hardware the modified personalized simulated cardiac model to display.

34. The method of claim 32, further comprising displaying, on the display modified personalized simulated cardiac model.

35. A cardiac modeling system comprising:
an imaging device configured to capture cardiac imagery indicative of fiber orientation of various areas in a heart of a subject; and
processing circuitry configured to:
obtain the cardiac imagery captured by the imaging device;
obtain a cardiac model indicative of a geometry of a heart;
generate a cardiac fiber orientation map by reconstructing the cardiac imagery according to the cardiac model; and
produce a cardiac activation simulation of the heart of the subject based on the cardiac fiber orientation map,
wherein the cardiac activation simulation is indicative of a propagation behavior of electric signals within the heart of the subject.
